(19) United States
(12) Patent Application Publication
(10) Pub. No.: US 2024/0117126 A1
(43) Pub. Date: Apr. 11, 2024

(54) HIGHLY FILLER-FILLED HIGHLY THERMALLY-CONDUCTIVE THIN SHEET HAVING SUPERIOR ELECTRICAL CHARACTERISTICS, CONTINUOUS MANUFACTURING METHOD AND CONTINUOUS MANUFACTURING DEVICE FOR SAME, AND MOLDED PRODUCT OBTAINED USING THIN SHEET

(71) Applicant: TAKAGI CHEMICALS, INC., Okazaki-shi, Aichi (JP)

(72) Inventors: Noriaki TAKAGI, Okazaki-shi, Aichi (JP); Masakuni TAKAGI, Okazaki-shi, Aichi (JP); Yuusuke NAGATANI, Okazaki-shi, Aichi (JP); Daisuke WATANABE, Okazaki-shi, Aichi (JP); Kazuo MATSUYAMA, Okazaki-shi, Aichi (JP)

(21) Appl. No.: 18/276,285

(22) PCT Filed: Feb. 15, 2022
(86) PCT No.: PCT/JP2022/005862

§ 371 Date: Aug. 8, 2023

(30) Foreign Application Priority Data
Feb. 18, 2021 (JP) 2021-024170

(51) Int. Cl. C08J 3/20; C08K 3/04; C08K 3/38

(52) U.S. Cl. CPC C08J 3/203; C08K 3/04; C08K 3/38; C08J 2371/12; C08J 2377/06; C08J 2381/02; C08J 2471/12; C08J 2477/06; C08J 2481/02; C08K 2003/385

(57) ABSTRACT

A high filler-loaded thermally conductive thin sheet is obtained by uniformly dispersing a mixture containing organic polymer particles and highly thermally conductive filler particles using a pulverizer or a mixer to obtain a powder composition, conveying the powder composition at a constant thickness between two belts of a double belt press device, and continuously heating and pressurizing the powder composition at a temperature higher than or equal to a deflection temperature under load, melting point, or a glass transition temperature of the organic polymer and at a specific pressure and then cooling and solidifying the powder composition in the double belt press device.

### TECHNICAL FIELD

The present invention relates to a high filler-loaded thermally conductive thin sheet having excellent electrical characteristics, a continuous production method and continuous production device for the same, and a molded article obtained using the thin sheet. More specifically, the present invention relates to a high filler-loaded thermally conductive thin sheet having excellent electrical conductivity or insulation properties, being excellent in weight reduction, mechanical strength, designability, moldability, mass productivity, recyclability, and the like of electronic and electrical equipment, and having a uniform sheet thickness, which is formed by continuously heating and pressurizing a powder composition, in which the periphery of highly thermally conductive filler particles is covered with pulverized organic polymer particles, and cooling and solidifying the powder composition.

### BACKGROUND ART

In response to an increase in global environmental awareness such as SDGs (Sustainable Development Goals) or ESG (Environment, Social, Governance) investment, efforts have been made to spread and expand next-generation automobiles such as fuel cell vehicles (FCVs) and electric vehicles (EVs). At the moment, cost is a bottleneck in widespread use of FCVs, and efficiency improvement of a power conversion system (power device) and an increase in secondary battery capacity are bottlenecks in EVs. Therefore, the development of low-cost and highly efficient materials and manufacturing techniques is an urgent issue.

For the FCVs, a polymer electrolyte fuel cell (PEFC) is used because of a low operating temperature and a high power density, and as a PEFC stack member, there are an electrode material, an electrolyte layer, a separator, and a gas diffusion layer, and miniaturization, weight reduction, high performance, reduction in the number of parts, and cost reduction for mass production are immediate problems. The separator includes a carbon-based separator and a metal-based separator. Currently, the latter is mainly used, but there are problems such as weight reduction, corrosion resistance, and cost reduction, and development of a separator using a composite material of carbon (general term for carbon materials, including graphite) and a resin, which is easy to respond to various demands from downstream manufacturers, has attracted attention.

For example, Patent Literature 1 discloses a fuel cell separator that uses a thermoplastic elastomer as a modifier in combination with a carbon material and a thermosetting resin, and satisfies flexibility, gas barrier properties, durability, electrical conductivity, and the like. Patent Literature 2 discloses a fuel cell separator obtained by preparing a sheet using, as a raw material, a conductive resin composition composed of a carbonaceous material (A) and a thermoplastic resin composition (B) at a mass ratio A/B=1 to 20 with an extruder-mill roll, heating and stamping the sheet in a molten state, and cooling and shaping the sheet. Patent Literature 3 discloses a fuel cell separator excellent in mechanical strength, electrical conductivity, and water repellency provided using a molding material containing a thermoplastic resin, which contains a PPS resin and a fluororesin, and further containing graphite. Patent Literature 4 discloses a high filler-loaded thermally conductive material obtained by pulverizing a thermally conductive filler having a graphite-like structure and organic polymer particles by frictional force or impact force using a pulverizer that grinds powders to obtain a powder composition having conditions that the filler is uniformly dispersed and a thermally conductive infinite cluster having a thermal conductivity of 5 to 150 W/mK is formed, and press-molding and cooling/solidifying the composition at a specific temperature and pressure.

Incidentally, with the spread of next-generation automobiles, the importance of power converters (power devices) such as inverters and converters has increased. From the viewpoints of coping with a large current, greatly improving efficiency, reducing fuel consumption, and the like, next-generation power semiconductors such as silicon carbide (SiC), gallium nitride (GaN), and gallium oxide (Ga₂O₃) have attracted attention instead of the current power semiconductors made of silicon (Si) since the next-generation power semiconductors have high conversion efficiency and excellent heat resistance, can operate at a high temperature of 250 to 300° C., and can simplify heat dissipation design. Since practical application in electric trains has already progressed, mounting on next-generation automobiles is expected, but problems peculiar to automobiles that are not present in electric trains, such as connection with other components, thermal stress due to temperature cycles, vibration, and service period (life), and particularly, problems on peripheral components and members remain, and next-generation automobiles have not yet sufficiently spread.

A thermal interface material (TIM) improves thermal resistance between a semiconductor chip and a heat sink in a power device, includes a heat dissipation sheet and heat dissipation grease, and is sometimes referred to as a core material or a prepreg. The TIM is required to have a soft property of filling concavities and convexities of material interface and high thermal conductivity in order to lower thermal resistance. In order to increase the thermal conductivity, it is necessary to increase the concentration of the insulating highly thermally conductive filler, and conversely, when the filler concentration is increased, the filler becomes brittle, and various ingenuities have been taken to overcome this trade-off relationship.

For example, Patent Literature 5 discloses an epoxy resin composition containing hexagonal boron nitride particles, a liquid crystalline epoxy monomer, and a curing agent, the epoxy resin composition being capable of forming a cured product having high thermal conductivity and high insulation resistance by reacting the liquid crystalline monomer with the curing agent, a thermally conductive material precursor using the epoxy resin composition, and the like. Patent Literature 6 discloses a circuit component module which allows mounting or incorporation of a high-power device using a sheet-shaped solid cured product composition containing an inorganic filler, a curable composition, and a thermoplastic resin powder. Patent Literature 7 discloses a resin composition containing an aggregate of hexagonal boron nitride primary particles and TIM for transferring heat of a heat-generating electronic component such as a power device.

In order to rapidly develop a wireless network, a satellite radar, and 5G communication, intelligence connection (Intelligence Connectivity), an elastic network (Elastic RAN), and a massive array antenna (Massive MIMO) are also constructed, and with the arrival of the 5G era, a new electronic communication service and an automatic driving service of an automobile, which are different from the conventional ones, can be provided to consumers. For this reason, in the automatic operation, materials and techniques such as a MEMS laser welding material for downsizing and modularization of a sensor, an electromagnetic shielding material for preventing malfunctions and interference, a low dielectric constant-low dielectric loss tangent material corresponding to a high frequency, a high capacity battery for improving performance of an electric vehicle, and weight reduction are required, and in 5G communication, materials and techniques such as a low dielectric constant-low dielectric loss tangent material corresponding to a high frequency, a flame retardant and high thermally conductive material for heat generation by downsizing and high speed signal processing, and a high capacity battery for long-term use of a compatible smartphone are required.

In particular, the output power of 5G electronic products is constantly increasing, and the corresponding application frequency is also greatly improved to the millimeter wave band (30 to 300 GHz), and the heat dissipation property of the material is strongly required. In order to enhance the heat dissipation property of the resin, a thermally conductive filler composite material is usually used, but in order to reduce the transmission loss in high-frequency signal processing, a filler-loaded composite material having both dielectric performance and thermal conduction characteristics has been required.

For example, Patent Literature 8 discloses a prepreg for a high frequency circuit board and a fluororesin composition for producing a copper-clad substrate, which are composed of one or more fluorine-containing copolymers selected from the group consisting of a polytetrafluoroethylene resin, a tetrafluoroethylene/perfluoroalkoxy vinyl ether copolymer, or a perfluoroethylene propylene copolymer, a low-molecular-weight polytetrafluoroethylene fine powder, and an inorganic powder (filler) and have excellent dielectric performance and thermal conduction characteristics. Patent Literature 9 discloses a metal foil with resin obtained by applying a dispersion containing a powdery fluoropolymer to a surface of a metal foil treated with an alkoxysilane having a functional group and heating the dispersion.

On the other hand, several methods for continuously producing sheets using a double belt press device are known. For example, Patent Literature 10 discloses a fuel cell separator having a multilayer structure in which a mixed felt of carbon fibers and polyphenylene sulfide resin fibers is disposed on and sandwiched between both surfaces of an expanded graphite sheet. Patent Literature 11 discloses an electrode substrate for a fuel cell, including a resin cured sheet obtained by continuously heat-pressing a resin-impregnated paper in which a thermosetting resin is impregnated into a carbon fiber paper. Patent Literature 12 discloses a heat dissipation sheet formed from a boron nitride filler and a thermosetting resin. Patent Literature 13 discloses a joint body including a polymer electrolyte membrane. Patent Literature 14 discloses a pressing device including a thickness adjustment mechanism capable of accurately holding a gap between pressure heads by applying a pressing force of an object to be pressed in a balanced manner to an opposing surface of a wedge that holds the gap between pressure heads constant. Patent Literature 15 discloses a vibratory conveyor for increasing a conveyance amount on a trough.

### CITATION LIST

### Patent Literatures

Patent Literature 1: JP 6232823 B2
Patent Literature 2: JP 5068051 B2
Patent Literature 3: JP 2013-120737 A
Patent Literature 4: JP 6034876 B2
Patent Literature 5: WO 2016/190260 A
Patent Literature 6: JP 2003-347705 A
Patent Literature 7: JP 2018-20932 A
Patent Literature 8: JP 2020-50860 A
Patent Literature 9: JP 2020-55241 A
Patent Literature 10: JP 2001-15131 A
Patent Literature 11: JP 2010-3564 A
Patent Literature 12: JP 2015-167181 A
Patent Literature 13: WO 2017/086304 A
Patent Literature 14: JP 2007-105783 A
Patent Literature 15: JP 2020-50496 A

### SUMMARY OF INVENTION

### Technical Problem

With the spread of next-generation automobiles, demands for electrically-powered component materials such as fuel cell vehicle separator materials and thermal interface materials (TIM) for power devices have been made from the viewpoint of cost reduction and improvement in recyclability as well as improvement in various performances thermal conductivity, electrical conductivity, insulation properties, weight reduction, mechanical properties, durability, designability, moldability, uniformity, and the like. In response to such various demands, as described above, instead of a single material such as metal or ceramics which has been widely used heretofore, a composite material of a highly thermally conductive filler such as graphite or ceramics and a resin has attracted attention. However, there is currently no product that satisfies such various requirements.

That is, in Patent Literature 1, since a compatibilizer and a solvent are required to uniformly disperse a carbon material, a thermosetting resin, and a thermoplastic elastomer, not only a manufacturing process and process management become complicated, and it becomes difficult to obtain a stable product, but also an eluate based on a compatibilizer, a thermosetting resin, a curing accelerator, a catalyst, and the like which are not originally required adversely affects the performance of a fuel cell. In Patent Literature 2, the surface of the carbonaceous material is covered with a thick resin because the carbonaceous material is kneaded at a temperature higher than or equal to the melting point in the production of a conductive resin composition, extrusion molding is performed at a temperature higher than or equal to the melting point of the resin in the production of the sheet, and then roll stretching is performed, so that the filler and the resin are separated, the surface of the sheet is covered with a skin layer of the resin, and the surface becomes uneven due to the linear pressure by the roll, for example, which adversely affects the sheet performance. The compression molding method described as a production method for a fuel cell separator in Patent Literature 3 is a batch process, the productivity is significantly reduced, and an injection molding method, a compression injection molding method, and a transfer molding method have disadvantages that a resin skin layer is formed on the surface, which causes a decrease in electrical conductivity, for example. In Patent Literature 4, a resin composition having high thermal conductivity and high electrical conductivity can be obtained, but since high performance can be exhibited in hot press molding, productivity is significantly reduced, and there is a disadvantage that the resin composition is not suitable for production of a thin sheet which is inexpensive and requires a large amount.

In Patent Literature 5 and Patent Literature 6, an epoxy resin is used as a main raw material, not only polar parts such as a curing agent and a curing accelerator used in combination and polar impurities contained therein adversely affect the insulation properties, but also it is difficult to manage the B-stage in a semi-cured state, which adversely affects a final product. In Patent Literature 7, when a thermosetting resin is used as a main resin, problems in insulation properties and process management occur as described above, and when a thermoplastic resin is used, problems similar to those in Patent Document 4 occur.

In Patent Literature 8, a pre-impregnating solution of a fluororesin composition is prepared by uniformly stirring an emulsion of a resin and an inorganic powder, this solution is repeatedly applied to a glass fiber cloth and dried to prepare a prepreg, and a copper foil is pasted to the prepreg under a high temperature and a high pressure to produce a copper-clad substrate, which is time-consuming and expensive. Patent Literature 9 describes a method of forming a fluoropolymer layer by applying a dispersion containing a fluoropolymer powder to a surface of a metal foil having a predetermined silane-treated surface, but does not describe a method of forming a fluoropolymer layer by directly adhering a powder composition to a copper foil and a method for continuously producing a fluoropolymer layer.

On the other hand, Patent Literature 10 to Patent Literature 15 describe various continuous production methods of sheets using a double belt press device, but do not describe a method for directly producing a sheet excellent in electrical characteristics from a powder composition. Patent Literature does not describe that the vibratory conveyor is connected to a double belt press machine to produce a thin sheet having a uniform sheet thickness.

Therefore, an object of the present invention is to provide a means capable of continuously producing an excellent high filler-loaded thermally conductive thin sheet that satisfies various requirements such as thermal conductivity, electrical conductivity, insulation properties, weight reduction, mechanical properties, durability, designability, moldability, mass productivity, and uniformity.

### Solution to Problem

The present inventors have conducted intensive studies in order to solve the above problems, and as a result, have found that an excellent high filler-loaded thermally conductive thin sheet that satisfies various requirements such as thermal conductivity, electrical conductivity, insulation properties, weight reduction, mechanical properties, durability, designability, moldability, mass productivity, and uniformity can be continuously produced by uniformly dispersing a mixture containing organic polymer particles and highly thermally conductive filler particles using a pulverizer or a mixer to obtain a powder composition, conveying the powder composition at a constant thickness between two belts of a double belt press device, and continuously heating and pressurizing the powder composition at a temperature higher than or equal to a deflection temperature under load, melting point, or a glass transition temperature of the organic polymer and at a specific pressure and then cooling and solidifying the powder composition in the double belt press device, thereby completing the present invention.

The background thereof will be described in detail below. The powder composition is carefully loaded in a mold so that the sheet thickness is constant, and heated and pressurized using a vacuum press device while defoaming under vacuum, whereby a high filler-loaded thermally conductive thin sheet having performance close to the required characteristics can be obtained. However, this method is batch production, and it takes a considerable time to fill the mold with the powder composition, and to pressurize, heat-melt, cool-solidify, and take out the powder composition. Thus, there is a difficulty in productivity, and it is not possible to respond to a demand for an electrically-powered component material which has been widely used and requires cost reduction.

In this regard, first, a thick sheet was prepared and heat-molded into a thin sheet using a stretching roll press device, but the sheet could not be sufficiently heated due to line heating and linear pressure, and concavities and convexities were generated on the sheet surface, so that a product having stable quality could not be obtained. An attempt was made to prepare a sheet by directly supplying the powder composition to a stretching roll press machine and pressurizing and heating the powder composition, but the powder composition was brittle and was difficult to handle, and a sheet that could be molded in the next step could not be obtained.

However, when the sheet obtained using a press machine was pressurized and heated on a belt surface using a double belt press device, a sheet having a surprisingly favorable stretched surface was obtained. When the powder composition was conveyed to a double belt press device while being controlled so that the thickness of the powder was constant, and heated and pressurized, and then cooled and solidified, it was found that a high filler-loaded thermally conductive thin sheet satisfying the various requirements described above as well as having excellent sheet surface properties can be continuously produced without using a special device having a defoaming function. That is, the present invention solves the problems described above by the following means.

(1) A high filler-loaded thermally conductive thin sheet, formed by
obtaining a powder composition including organic polymer particles containing a thermoplastic polymer and highly thermally conductive filler particles having a thermal conductivity of 10 W/mK or more, the powder composition having conditions that 5 to 60 wt % of the organic polymer particles and 40 to 95 wt % of the highly thermally conductive filler particles with respect to 100 wt % of the total amount of the organic polymer particles and the highly thermally conductive filler particles are uniformly dispersed using a pulverizer or a mixer, a thermally conductive infinite cluster is formed, and a concentration of the thermally conductive filler is more than or equal to a percolation threshold,
conveying, using a conveying device, the powder composition at a constant thickness between a first belt and a second belt of a double belt press device, the double belt press device including the first belt made of metal that is wound around a plurality of first driving rollers and circulates, the second belt made of metal that is wound around a plurality of second driving rollers and circulates below the first belt, and a pressurizing device and a heating device, or a pressurizing device, a heating device, and a cooling device that are respectively disposed between the plurality of first driving rollers and between the plurality of second driving rollers in a pressurization region where the first belt and the second belt face each other, and
continuously heating and pressurizing the powder composition at a temperature higher than or equal to a deflection temperature under load, melting point, or glass transition temperature of the organic polymer and at a pressure of 0.05 to 30 MPa and then cooling and solidifying the powder composition in the double belt press device;

(2) The high filler-loaded thermally conductive thin sheet according to (1), wherein
the highly thermally conductive filler particles have a graphite-like structure, and
the pulverizer or the mixer is a pulverizer that grinds the highly thermally conductive filler particles by frictional force or impact force;

(3) The high filler-loaded thermally conductive thin sheet according to (1) or (2), wherein the pulverizer or the mixer is a ball mill, a bead mill, or a medium mill;

(4) The high filler-loaded thermally conductive thin sheet according to any one of (1) to (3), wherein a sheet thickness is 0.05 to 3 mm;

(5) The high filler-loaded thermally conductive thin sheet according to any one of (1) to (4), wherein a thermal conductivity of the thermally conductive infinite cluster is 5 to 150 W/mK;

(6) The high filler-loaded thermally conductive thin sheet according to any one of (1) to (5), wherein the thermoplastic polymer particles include at least one selected from the group consisting of thermoplastic resin particles and thermoplastic elastomer particles all of which have crystallinity and/or aromaticity;

(7) The high filler-loaded thermally conductive thin sheet according to (6), wherein the thermoplastic polymer particles include the thermoplastic resin particles having crystallinity and/or aromaticity and a thermoplastic elastomer including a non-particulate shape;

(8) The high filler-loaded thermally conductive thin sheet according to (6) or (7), wherein the thermoplastic resin particles include at least one selected from the group consisting of polytetrafluoroethylene, a copolymer of tetrafluoroethylene and perfluoroalkyl vinyl ether, polyphenylene sulfide, polyethylene terephthalate, polybutylene terephthalate, semi-aromatic polyamide, aliphatic polyamide, polypropylene, heat-resistant polyimide, polyether sulfone, polyether ether ketone, syndiotactic polystyrene, polyphenylene ether, and polycarbonate;

(9) The high filler-loaded thermally conductive thin sheet according to any one of (6) to (8), wherein the thermoplastic elastomer particles include at least one selected from the group consisting of a polystyrene-based elastomer, a polyamide-based elastomer, and a fluoro-rubber-based elastomer;

(10) The high filler-loaded thermally conductive thin sheet according to any one of (1) to (9), wherein the organic polymer particles contain a thermosetting elastomer;

(11) The high filler-loaded thermally conductive thin sheet according to any one of (1) to (10), wherein the organic polymer particles further include uncured thermosetting resin particles having aromaticity including crystallinity and/or amorphousness;

(12) The high filler-loaded thermally conductive thin sheet according to (11), wherein the organic polymer particles further include an uncured thermosetting resin including a non-particulate shape;

(13) The high filler-loaded thermally conductive thin sheet according to (11) or (12), wherein the thermosetting resin particles having aromaticity including crystallinity and/or amorphousness include at least one selected from the group consisting of benzoxazine and bismaleimide;

(14) The high filler-loaded thermally conductive thin sheet according to any one of (1) to (13), wherein the highly thermally conductive filler particles have a graphite-like structure, and the highly thermally conductive filler particles contain graphite;

(15) The high filler-loaded thermally conductive thin sheet according to (14), wherein the graphite includes at least one selected from the group consisting of natural graphite, artificial graphite, and expanded graphite;

(16) The high filler-loaded thermally conductive thin sheet according to (14) or (15), wherein a thermal conductivity and a surface electrical conductivity of the thermally conductive infinite cluster are 10 to 150 W/mK and 5 to 200 (Ωcm)⁻¹, respectively;

(17) The high filler-loaded thermally conductive thin sheet according to any one of (1) to (13), wherein the highly thermally conductive filler particles have a graphite-like structure, and the highly thermally conductive filler particles contain thermally conductive ceramics;

(18) The high filler-loaded thermally conductive thin sheet according to (17), wherein the thermally conductive ceramics contains hexagonal boron nitride;

(19) The high filler-loaded thermally conductive thin sheet according to any one of (1) to (13), (17), and (18), wherein a dielectric constant is 2.0 to 4.5, and a dielectric loss tangent is 0.0005 to 0.015;

(20) The high filler-loaded thermally conductive thin sheet according to (19), wherein a dielectric constant and a dielectric loss tangent of the thermoplastic resin are 2.0 to 3.7 and 0.00001 to 0.005, respectively, and a dielectric constant and a dielectric loss tangent of the highly thermally conductive filler are 3.0 to 5.0 and 0.00001 to 0.005, respectively;

(21) The high filler-loaded thermally conductive thin sheet according to (19) or (20), wherein the organic polymer particles include at least one selected from the group consisting of polyphenylene sulfide, polytetrafluoroethylene, a copolymer of tetrafluoroethylene and perfluoroalkyl vinyl ether, polyether ether ketone, heat-resistant polyimide, polyphenylene ether, and a liquid crystalline polyester polymer, and the highly thermally conductive filler particles include hexagonal boron nitride;

(22) The high filler-loaded thermally conductive thin sheet according to any one of (17) to (21), wherein the powder composition further contains whisker-like ceramics;

(23) The high filler-loaded thermally conductive thin sheet according to any one of (17) to (22), wherein a thermal conductivity and an electrical conductivity of the thermally conductive infinite cluster are 5 to 50 W/mK and 10⁻¹⁰ (Ωcm)⁻¹ or less, respectively;

(24) The high filler-loaded thermally conductive sheet according to any one of (17) to (23), wherein the organic polymer particles contain a thermoplastic polymer and an uncured thermosetting resin, a deflection temperature under load or melting point of the thermoplastic polymer is equal to or lower than a curing temperature of the thermosetting resin, and a heating temperature in the double belt press device is a temperature higher than or equal to the deflection temperature under load or melting point of the thermoplastic polymer and equal to or lower than the curing temperature of the thermosetting resin;

(25) The high filler-loaded thermally conductive sheet according to any one of (1) to (24), wherein conveying of the powder composition in the double belt press device is performed in such a manner that a film is placed on the second belt or on the first belt and the second belt and the powder composition placed on the film on the second belt is conveyed;

(26) The high filler-loaded thermally conductive sheet according to (25), wherein the film is a release film formed from a heat-resistant polyimide or a metal foil;

(27) The high filler-loaded thermally conductive sheet according to (26), wherein the metal foil is a copper foil, and an adhesive is applied to a surface of one side of the copper foil in contact with the powder composition;

(28) The high filler-loaded thermally conductive sheet according to (27), wherein the adhesive is formed from an epoxy resin and a curing accelerator;

(29) The high filler-loaded thermally conductive thin sheet according to any one of (1) to (28), wherein the conveying device includes a vibratory conveying device;

(30) The high filler-loaded thermally conductive thin sheet according to any one of (1) to (29), wherein the pressurizing device includes a surface pressurizing device using a flowable liquid to a surface of the first belt and/or the second belt of the double belt press device;

(31) The high filler-loaded thermally conductive thin sheet according to any one of (1) to (30), wherein the powder composition further contains whisker-like ceramics;

(32) A reprocessed high filler-loaded thermally conductive thin sheet, formed by heating and pressurizing the high filler-loaded thermally conductive thin sheet according to any one of (1) to (31) at a temperature higher than or equal to the deflection temperature under load, melting point, or glass transition temperature of the organic polymer and at a pressure of 0.05 MPa or more and then cooling and solidifying the high filler-loaded thermally conductive thin sheet in at least one device selected from the group consisting of the double belt press device, a roll press device, and a heat press device;

(33) A production method for a high filler-loaded thermally conductive thin sheet, including:
a step (1) of preparing a powder composition including organic polymer particles containing a thermoplastic polymer and a highly thermally conductive filler having a thermal conductivity of 10 W/mK or more, the powder composition having conditions that 5 to 60 wt % of the organic polymer particles and 40 to 95 wt % of the highly thermally conductive filler with respect to 100 wt % of the total amount of the organic polymer particles and the highly thermally conductive filler particles are uniformly dispersed using a pulverizer or a mixer, a thermally conductive infinite cluster is formed, and a concentration of the thermally conductive filler is more than or equal to a percolation threshold;
a step (2) of conveying, using a conveying device, the powder composition at a constant thickness between a first belt and a second belt of a double belt press device, the double belt press device including the first belt made of metal that is wound around a plurality of first driving rollers and circulates, the second belt made of metal that is wound around a plurality of second driving rollers and circulates below the first belt, and a pressurizing device and a heating device, or a pressurizing device, a heating device, and a cooling device that are respectively disposed between the plurality of first driving rollers and between the plurality of second driving rollers in a pressurization region where the first belt and the second belt face each other; and
a step (3) of continuously heating and pressurizing the powder composition conveyed at a constant thickness at a temperature higher than or equal to a deflection temperature under load, melting point, or glass transition temperature of the organic polymer and at a pressure of 0.5 to 30 MPa and then cooling and solidifying the powder composition in the double belt press device;

(34) The production method for a high filler-loaded thermally conductive thin sheet according to (33), wherein the highly thermally conductive filler particles have a graphite-like structure, and the pulverizer or the mixer is a pulverizer that grinds the highly thermally conductive filler particles by frictional force or impact force;

(35) The production method for a high filler-loaded thermally conductive thin sheet according to (33) or (34), wherein the pulverizer or the mixer is a ball mill, a roller mill, a bead mill, or a medium mill;

(36) The production method for a high filler-loaded thermally conductive thin sheet according to any one of (33) to (35), wherein the pressurizing device includes a surface pressurizing device using a flowable fluid to a surface of the first belt and/or the second belt of the double belt press device;

(37) A production method for a reprocessed high filler-loaded thermally conductive thin sheet, including heating and pressurizing the thin sheet according to any one of (1) to (32) at a temperature higher than or equal to the deflection temperature under load, melting point, or glass transition temperature of the organic polymer and at a pressure of 0.05 MPa or more and then cooling and solidifying the high filler-loaded thermally conductive thin sheet in at least one device selected from the group consisting of the double belt press device, a roll press device, and a heat press device;

(38) A production device for a high filler-loaded thermally conductive thin sheet for use in the production method according to any one of (33) to (37), including:
a double belt press device including a first belt made of metal that is wound around a plurality of first driving rollers and circulates, a second belt made of metal that is wound around a plurality of second driving rollers and circulates below the first belt, and a pressurizing device and a heating device, or a pressurizing device, a heating device, and a cooling device that are respectively disposed between the plurality of first driving rollers and between the plurality of second driving rollers in a pressurization region where the first belt and the second belt face each other; and
a conveying device for conveying the powder composition at a constant thickness between the first belt and the second belt;

(39) The production device for a high filler-loaded thermally conductive thin sheet according to (38), wherein the pressurizing device includes a surface pressurizing device using a flowable fluid;

(40) The production device for a high filler-loaded thermally conductive thin sheet according to (38) or (39), wherein the double belt press device includes a thickness adjustment mechanism capable of adjusting a thickness of an object to be pressed;

(41) The production device for a high filler-loaded thermally conductive thin sheet according to any one of (38) to (40), wherein the conveying device is a vibratory conveying device;

(42) A molded article comprising the high filler-loaded thermally conductive thin sheet according to any one of (1) to (32), a high filler-loaded thermally conductive thin sheet obtained by the production method according to any one of (33) to (37), or a high filler-loaded thermally conductive thin sheet obtained by the production device according to any one of (38) to (41), the molded article being used as an electrical or electronic component;

(43) The molded article according to (42), wherein
the molded article is formed by laminating two layers of the high filler-loaded thermally conductive thin sheet,
a thermal conductivity and a surface electrical conductivity of one layer of the two layers are 5 to 50 W/mK and 10⁻¹⁰ (Ωcm)⁻¹ or less, respectively, and
a thermal conductivity and a surface electrical conductivity of the other layer of the two layers are 10 to 150 W/mK and 5 to 350 (Ωcm)⁻¹, respectively.

### BRIEF DESCRIPTION OF DRAWINGS

FIG. 1 is a view illustrating a device for continuously producing a thin sheet from supply of a powder composition as a raw material using a double belt press device.

FIG. 2 is a view showing nitrogen atom mapping in SEM/EDX analysis of a thin sheet.

### DESCRIPTION OF EMBODIMENTS

Hereinafter, embodiments for carrying out the present invention will be described in detail.

<High Filler-Loaded Thermally Conductive Thin Sheet>

According to an embodiment of the present invention, there is provided a high filler-loaded thermally conductive thin sheet, formed by obtaining a powder composition including organic polymer particles containing a thermoplastic polymer and highly thermally conductive filler particles having a thermal conductivity of 10 W/mK or more, the powder composition having conditions that 5 to 60 wt % of the organic polymer particles and 40 to 95 wt % of the highly thermally conductive filler particles with respect to 100 wt % of the total amount of the organic polymer particles and the highly thermally conductive filler particles are uniformly dispersed using a pulverizer or a mixer, a thermally conductive infinite cluster is formed, and a concentration of the thermally conductive filler is more than or equal to a percolation threshold,
conveying, using a conveying device, the powder composition at a constant thickness between a first belt and a second belt of a double belt press device, the double belt press device including the first belt made of metal that is wound around a plurality of first driving rollers and circulates, the second belt made of metal that is wound around a plurality of second driving rollers and circulates below the first belt, and a pressurizing device and a heating device, or a pressurizing device, a heating device, and a cooling device that are respectively disposed between the plurality of first driving rollers and between the plurality of second driving rollers in a pressurization region where the first belt and the second belt face each other, and
continuously heating and pressurizing the powder composition at a temperature higher than or equal to a deflection temperature under load, melting point, or glass transition temperature of the organic polymer and at a pressure of 0.05 to 30 MPa and then cooling and solidifying the powder composition in the double belt press device.

The high filler-loaded thermally conductive thin sheet according to the present invention is obtained by pulverizing organic polymer particles including thermoplastic polymer particles and highly thermally conductive filler particles using a pulverizer or a mixer to obtain a powder composition in which the organic polymer particles and the highly thermally conductive filler particles are uniformly dispersed and heating and pressurizing and then cooling and solidifying the powder composition using a double belt press device.

A thin sheet excellent in thermal conductivity, electrical characteristics, mechanical strength, surface smoothness, and the like can be continuously produced by simple process directly using a powder raw material without using a special device for removing voids. For this reason, as compared with a conventional batch method using vacuum hot press forming, excellent thinning can be achieved and productivity can be remarkably improved.

In a heat press device, cooling and solidification occur from the upper and lower sides toward the center of the sheet, whereas in a double belt press device, cooling and solidification occur from the side surface of the sheet in a direction opposite to the traveling direction of the sheet. For this reason, when the molten thermoplastic polymer is cooled and solidified, a difference is caused in the orientation of the highly thermally conductive filler, particularly, the filler having a graphite-like structure with a flat structure. Usually, when the thermoplastic polymer is melted, the filler is oriented in a direction perpendicular to a pressing direction, but anisotropy can be relaxed by changing the orientation of the filler during cooling and solidification.

In the powder composition according to the present invention, the highly thermally conductive filler particles and the organic polymer particles, which are formed from a thermoplastic resin, a thermoplastic elastomer, a thermosetting elastomer, and an uncured thermosetting resin, having different hardness (ease of pulverization), polarity (affinity), melting point/softening temperature, and the like, are pulverized and/or mixed, whereby the shape of the hard filler is not largely impaired, and the periphery of the filler is covered with a uniform thin film of the pulverized organic polymer, whereby the surface of the filler particles activated by pulverization and mixing is stabilized. At the time of melting the organic polymer, those having high affinity adhere to each other without significantly changing the distribution/shape of the composition, and at the stage of producing a thin sheet by cooling and solidification, a thermal conductive and/or electrical conductive path is formed without reducing the mechanical strength even in high filler loading by so-called morphology control in which a filler-rich phase and a filler-non-rich phase are formed, so that excellent thermal conductivity and/or electrical conductivity can be exhibited.

By selecting the powder composition component, performance and physical properties suitable for the purpose can be exhibited, and the degree of freedom in material design is high. For example, in the case of the highly thermally conductive filler, thermal conductivity, electrical conductivity, insulation properties, or the like can be imparted, in the case of the thermoplastic resin, heat resistance, strength, or the like can be imparted, in the case of the thermoplastic elastomer and the thermosetting elastomer, flexibility and surface smoothness can be imparted, adhesion/adhesiveness between different materials and thermal cyclability (use at a low temperature) can be improved, and in the case of the uncured thermosetting resin, strength, hardness, adhesion/adhesiveness, or the like can be imparted. By using a low dielectric constant-low dielectric loss tangent material as the highly thermally conductive filler and the organic polymer, the material can be used as a material corresponding to a high frequency such as 5G or 6G.

The high filler-loaded thermally conductive thin sheet according to the present invention uses a thermoplastic polymer that can be softened and molded by heating and has a property of being solidified by cooling (this also has reversibility), and thus the characteristics thereof can be effectively utilized. That is, it is possible to perform molding processing into various shapes by performing a heat treatment using a mold, and at the time of joining between different materials (for example, an insulating material and a conductive material), firm bonding is possible at the interface between the different materials by the thermoplastic polymer in each material without using an adhesive or the like, and the mechanical strength can be maintained without a large loss of thermal conductivity and/or electrical conductivity at the interface. Specific examples thereof include an integrally molded product of a conductive and insulating high filler-loaded thermally conductive thin sheet, a multilayer sheet of a copper foil and an insulating highly thermally conductive thin sheet, and the like.

Since the high filler-loaded thermally conductive thin sheet according to the present invention is configured as described above, the high filler-loaded thermally conductive thin sheet is excellent in mass productivity by continuous production, and can exhibit characteristics such as lightweight properties, molding processability, cutting processability, integral moldability, dimensional stability, and improvement of physical properties according to applications of the organic polymer while taking advantage of the characteristics of the highly thermally conductive filler to the utmost even in the presence of an organic polymer (generally, a thermal insulating material and an insulating material) that inhibits the expression of thermal conductivity and/or electrical conductivity, and can be used as an electrical or electronic component in which thermal conductivity and electrical conductivity or insulation properties are strongly required.

For example, a graphite filler-containing conductive thin sheet can be used as a fuel cell separator excellent in electrical conductivity (contact resistance), thermal conductivity, lightweight properties, acid resistance, drainage properties, integral moldability, or the like, a casing of an electrical or electronic component excellent in heat dissipation property, or the like by forming a flow path using a heat press machine or a cutting machine. A hexagonal boron nitride filler-containing insulating thin sheet can be cut into an appropriate shape as it is, and used for electrical or electronic components that significantly generate heat due to high performance and miniaturization, such as thermal interface materials (TIM) for power devices and copper-clad substrates thereof, LED backlights, high-brightness LED substrates, and casings of next-generation smartphones, which are excellent in thermal conductivity, heat resistance, insulation properties (dielectric breakdown voltage), adhesiveness/adhesion with metals, high strength and high elasticity, impact resistance, safety and reliability, and the like. By combining a low dielectric constant-low dielectric loss tangent filler with an organic polymer, the obtained material can also be used as a high-frequency compatible member for 5G or 6G.

The thermal conductivity of the high filler-loaded thermally conductive thin sheet according to the present embodiment is preferably 5 to 150 W/mK, more preferably 10 to 100 W/mK, and further preferably 15 to 80 W/mK. A hot disc method is used in measurement of the thermal conductivity. When the highly thermally conductive filler is an anisotropic material and the filler is oriented in a plane direction, the thermal conductivity is higher than that in a steady state method (temperature gradient method).

A coefficient of thermal expansion of the high filler-loaded thermally conductive thin sheet according to the present embodiment is preferably 3×10⁻⁶ to 30×10⁻⁶° C.⁻¹. In an embodiment of the present invention, when the high filler-loaded thermally conductive thin sheet is used for being brought into contact with a material having a smaller coefficient of thermal expansion such as a semiconductor element or a ceramic substrate, the coefficient of thermal expansion is more preferably 3×10⁻⁶ to 20×10⁻⁶° C.⁻¹. In another embodiment of the present invention, when the high filler-loaded thermally conductive thin sheet is used for being brought into contact with a heat dissipation component formed from a metal such as aluminum or copper, the coefficient of thermal expansion is more preferably 10×10⁻⁶ to 30×10⁻⁶° C.⁻¹.

In another embodiment of the present invention, when the high filler-loaded thermally conductive thin sheet according to the present embodiment is a conductive material (for example, when the highly thermally conductive filler is graphite), a surface electrical conductivity is preferably 3 to 500 (Ωcm)⁻¹, more preferably 5 to 350 (Ωcm)⁻¹, and further preferably 15 to 150 (Ωcm)⁻¹. In another embodiment of the present invention, when the high filler-loaded thermally conductive thin sheet is an insulating material (for example, when the highly thermally conductive filler is hexagonal boron nitride), a surface electrical conductivity is preferably 1×10⁻¹⁰ (Ωcm)⁻¹ or less and further preferably 1×10⁻¹⁵ (Ωcm)⁻¹ or less.

(Powder Composition)

[Organic Polymer Particles]

An average particle size of the organic polymer particles used in the present invention is usually 1 to 5000 μm and preferably 5 to 3000 μm. When the average particle size of the organic polymer particles is 1 μm or more, no special device for micronization is needed. On the other hand, when the average particle size of the organic polymer particles is 5000 μm or less, defective dispersion is not likely to occur during pulverization and mixing. Organic polymer particles including lumpy objects having a large particle size can be used after being pretreated in advance by pulverization and/or crushing, classification and the like to obtain a desired average particle size. The organic polymer particles preferably have an aromatic hydrocarbon structure similar to the filler particles having a graphite-like structure, and it is particularly preferable that the organic polymer particles are crystallized or oriented around the filler in the presence of the filler along the plane direction of the filler.

Examples of the organic polymer particles that can be used include organic polymer particles mainly formed from thermoplastic polymer particles, specifically, thermoplastic polymer particles formed from a thermoplastic resin having crystallinity and/or aromaticity and a thermoplastic elastomer having crystallinity and/or aromaticity, all of which are used in the field of molding. A melting point of the crystalline thermoplastic resin is preferably 120° C. or higher, more preferably 130 to 450° C., and particularly preferably 150 to 400° C. The organic polymer according to the present invention can include a thermosetting resin precursor and/or a thermosetting elastomer (rubber) all of which are formed from an uncured thermosetting resin. The melting point can be determined from an endothermic peak at the time of melting using a differential scanning calorimeter (DSC) or a differential thermal differential thermal differential thermal analysis (DTA), and for an amorphous polymer having no melting point, a deflection temperature under load can be taken as a reference. A known thermoplastic polymer, which contains a graft copolymer containing an olefin-based polymer segment formed from an α-olefin monomer and a vinyl-based polymer segment formed from a vinyl-based monomer, can be included.

Examples of the crystalline aromatic thermoplastic resin particles include known thermoplastic polymers having crystallinity and aromaticity, such as aromatic polyesters such as polyethylene terephthalate, polybutylene terephthalate, polytrimethylene terephthalate, polyethylene naphthalate, and liquid crystal polyester, polyphenylene sulfide, semi-aromatic polyamide, aromatic polyimide precursor, heat-resistant thermoplastic polyimide, phenoxy resin, polyether ketone, polyether ether ketone, syndiotactic polystyrene, polystyrene, polybenzimidazole, and polyphenylene oxide. The semi-aromatic polyamide is a polyamide in which either a dicarboxylic acid or a diamine as a monomer is an aromatic compound, and has a high strength and improved water resistance and heat resistance. These resins are particularly preferable because when the resins have high affinity with fillers, the fillers can be firmly fixed by the crystallinity of the polymer grown on the filler surface and/or the compatibility with the fillers, the electrical conductivity or insulation properties and the thermal conductivity can be significantly enhanced without significantly impairing the mechanical properties, and the coefficient of thermal expansion can be appropriately controlled.

Examples of the non-aromatic crystalline thermoplastic resin particles include known thermoplastic resins having crystallinity, such as polyolefins such as polyethylene and polypropylene, polyoxymethylene, aliphatic polyamide, polymethyl methacrylate, polyvinyl chloride, polyvinylidene chloride, polyketone, fluorine-based resins such as a copolymer of tetrafluoroethylene and perfluoroalkyl vinyl ether, cycloolefin polymer, polyacetal, and ultrahigh-molecular-weight polyethylene. These resins are preferable because when the resins have high affinity with fillers, the fillers can be fixed by the crystallization of the polymer grown on the filler surface, the electrical conductivity or insulation properties and the thermal conductivity can be enhanced without impairing the mechanical properties, and the coefficient of thermal expansion can be controlled.

Examples of the amorphous aromatic thermoplastic resin particles include known amorphous thermoplastic polymers having an aromatic substituent, such as heat-resistant amorphous polyimide, polycarbonate, polyphenylene ether, polyarylate, polysulfone, polyethersulfone, polyetherimide, polyamideimide, and a liquid crystal polymer. Since these resins have a structure similar to that of the highly thermally conductive filler, when the resins have high affinity with fillers, there resins have high compatibility with the highly thermally conductive filler having a similar structure even if partial crystallization occurs or does not occur on the surface of the highly thermally conductive filler and/or around the surface of the highly thermally conductive filler in the presence of the highly thermally conductive filler, and thus the resins are in close contact with the filler well. Therefore, by fixing the fillers on the surface of the filler and/or around the surface of the filler, the electrical conductivity or insulation properties and the thermal conductivity can be enhanced without impairing the mechanical properties, and the coefficient of thermal expansion can be controlled, which is preferable. In a micro unit, crystallization often occurs, and the melting point can be confirmed by aging in some cases, but when the melting point cannot be confirmed, the deflection temperature under load can be measured and used as a reference.

In a preferred embodiment, a dielectric constant and a dielectric loss tangent of the thermoplastic resin are 2.0 to 3.7 and 0.00001 to 0.005, respectively.

In the thermoplastic resin particles, from the viewpoint of corresponding to a high frequency such as 5G, it is preferable that the dielectric constant is 2.0 to 3.7 and the dielectric loss tangent is 0.00001 to 0.015, and examples of low dielectric constant-low dielectric loss tangent materials corresponding thereto include polytetrafluoroethylene (εᵣ=2.1, tan δ=0.00001), a copolymer of tetrafluoroethylene and perfluoroalkyl vinyl ether (εᵣ=2.1, tan δ=0.00001), a liquid crystal polymer (εᵣ=3.3, tan δ=0.002), polyphenylene ether (εᵣ=3.5, tan δ=0.003), heat-resistant aromatic polyimide (εᵣ=3.3, tan δ=0.003), polyether ether ketone (εᵣ=2.8, tan δ=0.005), syndiotactic polystyrene (εᵣ=2.8 to 3.0, tan δ=0.001 to 0.002), and the like.

The thermoplastic elastomer particles are particles of an elastomer containing both of a flexible component (a rubber phase or a soft segment (hereinafter abbreviated as SS)) and a molecularly constrained component (a resin phase or a hard segment (hereinafter abbreviated as HS)) and having a property of softening and exhibiting fluidity when heat is applied to the elastomer and of returning to a rubber shape when the elastomer is cooled. There are various classification methods, but it is common to classify by the chemical composition of the hard segment. Examples thereof include known thermoplastic elastomers such as a styrene-based thermoplastic elastomer in which HS is polystyrene and SS is butadiene rubber (BR), isoprene rubber (IR), polyisoprene, polyisobutylene, hydrogenated BR, or hydrogenated IR, an olefin-based thermoplastic elastomer in which HS is polypropylene or polyethylene and SS is ethylene propylene diene rubber (EPDM), ethylene propylene rubber (EPM), ethylene butene rubber-like copolymer (EBM), butyl rubber (IIR), natural rubber (NR), hydrogenated styrene butadiene rubber, nitrile rubber (NBR), or acrylic rubber (ACM), a vinyl chloride-based thermoplastic elastomer in which HS is crystalline polyvinyl chloride (PVC) and SS is plasticized PVC or NBR, a urethane-based thermoplastic elastomer in which HS is polyurethane and SS is aliphatic polyester or aliphatic polyether, an ester-based thermoplastic elastomer in which HS is aromatic polyester and SS is aliphatic polyester or aliphatic polyether, an amide-based thermoplastic elastomer in which HS is polyamide and SS is aliphatic polyester, aliphatic polyether, ACM, or IIR, and a fluororesin-based thermoplastic elastomer in which HS is a fluororesin and SS is fluoro-rubber.

The thermosetting elastomer is usually called rubber, and includes natural rubber (NR) and synthetic rubber. Examples of the synthetic rubber include IR, BR, SBR, chloroprene rubber (CR), NBR, IIR, EPM, EPDM, chlorosulfonated polyethylene (CSM), ACM, fluoro-rubber, epichlorohydrin rubber, urethane rubber, silicone rubber, and the like, and known ones can be used.

When a powdery thermoplastic elastomer cannot be obtained, the thermoplastic elastomer can be used by being dissolved or uniformly dispersed in a solvent, uniformly applied to an organic polymer or a highly thermally conductive filler, and then evaporated to remove the solvent (non-particulate thermoplastic elastomer). In the case of using a thermosetting elastomer (crosslinked rubber), the particle size thereof is equal to or less than the sheet thickness of the thin sheet, and preferably 100 μm or less. When the particle size is 100 μm or less, it can contribute to impact resistance, thermal cyclability, and the like without significantly reducing the mechanical properties of the sheet.

Examples of the uncured thermosetting resin in a non-particulate state include known thermosetting resin precursors such as an unsaturated polyester resin, a vinyl ester resin, an epoxy resin, a phenol (resol-type) resin, a urea-melamine resin, a polyimide resin, a bismaleimide resin, a benzoxazine resin, and mixtures thereof all of which have an aromatic substituent. Since the thermosetting resin precursor is usually an oligomer having a small molecular weight, when the thermosetting resin precursor is used in combination with a thermoplastic polymer and/or a thermoplastic elastomer having a large molecular weight, the thermosetting resin precursor increases the fluidity in the system before curing, thereby the permeability of the polymer between filler layers. The adhesiveness between fillers and between different materials is improved by a functional group formed as a curing reaction proceeds. The thermosetting resin can contain a known reactive diluent for reducing the viscosity, a known curing agent that reacts with the thermosetting resin to form a crosslinked polymer, a known catalyst that initiates and/or accelerates a curing reaction of the thermosetting resin, and/or a known curing accelerator, and the like.

The thermoplastic resin having crystallinity and/or aromaticity or having amorphous aromaticity, the thermoplastic elastomer including a non-particulate shape, and the uncured thermosetting resin including a non-particulate shape may be a copolymer or a modified product, or may be a resin obtained by blending two or more kinds thereof. In particular, the combination of the crystalline thermoplastic resin and the amorphous thermoplastic resin is preferable because a synergistic effect utilizing the characteristics of both the crystalline thermoplastic resin and the amorphous thermoplastic resin can be exhibited in some cases. For example, when the crystalline thermoplastic resin is used alone, the adhesion to the filler can be enhanced by melting (viscosity reduction) by heating at a temperature higher than or equal to the melting point, but the shape of the molded product may be rapidly deformed. However, by using the amorphous thermoplastic resin in combination, rapid deformation of the crystalline thermoplastic resin at the time of melting can be suppressed. In order to further improve impact resistance, a resin obtained by adding a known thermoplastic elastomer or rubber component to the thermosetting resin may be used.

Among uncured thermosetting resins having a non-particulate shape, particularly, a benzoxazine resin is preferable because heat resistance is excellent, no volatile by-products are generated since curing proceeds by an addition reaction, and the reaction proceeds even in the absence of a catalyst, so that a uniform and dense resin phase can be formed. When a benzoxazine resin is used in combination with an epoxy resin, a bismaleimide resin, or the like, the benzoxazine resin acts as a curing accelerator for an epoxy resin, a bismaleimide resin, or the like, and can compensate for defects of an epoxy resin, a bismaleimide resin, or the like in terms of heat resistance, strength, or the like.

The benzoxazine is a compound having a dihydro-1,3-benzoxazine ring (hereinafter, also simply referred to as “oxazine ring”), and is a condensate of amines, phenols, and formaldehydes. Usually, the chemical structure of benzoxazine produced is determined by substituents, kinds, and the like of phenols, amines, and the like, which are reaction raw materials thereof. The benzoxazine used in the present invention may be any derivative or an “oxazine ring”, and is not particularly limited; however, a compound having at least two oxazine rings in one molecule is preferable. This is because the crosslinking density is increased, and superior results such as an enhancement of heat resistance are obtained. Specific examples of the benzoxazine include Pd type benzoxazine, Fa type benzoxazine, and the like, manufactured by SHIKOKU CHEMICALS CORPORATION.

The bismaleimide (resin) is usually obtained by condensing phthalic anhydride and aromatic diamine at a molar ratio of 2:1, specific examples thereof include 4,4′-diphenylmethane bismaleimide, m-phenylene bismaleimide, bisphenol A diphenyl ether bismaleimide, 3,3′-dimethyl-5,5′-diethyl-4,4′-diphenylmethane bismaleimide, 4-methyl-1,3-phenylene bismaleimide, 1,6′-bismaleimide-(2,2,4-trimethyl)hexane, 4,4-diphenyl ether bismaleimide, 4,4′-diphenylsulfone bismaleimide, 1,3-bis(3-maleimidophenoxy)benzene, 1,3-bis(4-maleimidophenoxy)benzene, and the like, and the bismaleimide (resin) can be used by being blended with reactive comonomers such as a vinyl compound, an allyl compound, allylphenol, isocyanate, aromatic amine, and benzoxazine.

The organic polymer particles consisting of a thermoplastic resin, a thermoplastic elastomer including a non-particulate shape, and/or an uncured thermosetting resin including a non-particulate shape are uncrosslinked/uncured in the mixture. As described below, the thermoplastic resin may be crosslinked when the mixture is heat-molded under pressure, and the thermoplastic elastomer or the uncured thermosetting resin is usually crosslinked/cured in a state of a thin sheet, but can also be used as a prepreg in an uncrosslinked/uncured state. For crosslinking/curing, a known catalyst, a curing accelerator, a crosslinking agent, and the like can be used.

Among these organic polymer particles, as organic polymer particles having high heat resistance and firmly fixing fillers therebetween to enhance various physical properties such as thermal conductivity and electrical characteristics, polytetrafluoroethylene, a copolymer of tetrafluoroethylene and perfluoroalkyl vinyl ether, heat-resistant thermoplastic polyimide, polyethylene terephthalate, polybutylene terephthalate, polyphenylene ether, polyphenylene sulfide, polycarbonate, semi-aromatic polyamide, aliphatic polyamide, polypropylene, polyether sulfone, polyether ether ketone, syndiotactic polystyrene, bismaleimide, and benzoxazine are suitable, and the characteristics of the organic polymer can be maximally exhibited by using various polymer particles in combination depending on the purpose of use.

[Highly Thermally Conductive Filler Particles]

The highly thermally conductive filler particles used in the present invention are known powdery filler particles such as graphite, metal, and ceramics, which have a thermal conductivity of 10 W/mK or more alone and are usually used as highly thermally conductive filler particles, but preferably include filler particles having a graphite-like structure. The average particle size thereof is preferably 1 to 1000 μm and more preferably 3 to 200 μm. When the average particle size of the highly thermally conductive filler particles is 1 μm or more, the surface area decreases, and the loss of heat and electric conduction at the filler interface can be reduced. On the other hand, when the average particle size of the thermally conductive filler is 1000 μm or less, defective dispersion is not likely to occur, and a thin sheet having favorable surface properties can be obtained, which is preferable. The ceramics described herein is a generic term for inorganic solid materials such as molded bodies, powders, and films of inorganic compounds such as oxides, carbides, nitrides, and borides, regardless of metals and non-metals.

The filler particles having a graphite-like structure used in the present invention are particles having a layered structure, and are an anisotropic material in which plane directions of layers are connected by strong bonding, and the layers are connected by weak bonding. Therefore, the filler particles are likely to be shifted in the plane direction, usually have slidability, and are used as a lubricating/mold releasing material. The term “delamination” means that detachment occurs between layers that are connected by weak bonding, while the state of connection in the plane direction of the layered filler is maintained unchanged, and the term “cohesive fracture” means that aggregated particles forming a cohesive state by weak bonding are broken to become original particles.

As the filler particles having a graphite-like structure, known thermally conductive fillers having a graphite-like structure which are used in the field of molding and formed from black leads (synonym for graphite) that usually have electrical conductivity, such as natural graphite such as scale-like graphite, bulk graphite, and soil graphite, artificial graphite, and expanded graphite; thermally conductive ceramics that usually have insulation properties, such as hexagonal boron nitride, hexagonal silicon carbide, and hexagonal silicon nitride; and sulfides such as molybdenum disulfide and tungsten disulfide; aggregated type boron nitride and graphite for alleviating anisotropy; and mixtures thereof, can be used without any particular limitations. In general, a material having an electrical conductivity of 10⁶ to 10² (Ωcm)⁻¹ is referred to as a conductor, a material having an electrical conductivity of 10 to 10⁻⁷ (Ωcm)⁻¹ is referred to as a semiconductor, and a material having an electrical conductivity of 10⁻¹⁰ to 10⁻¹⁸ (Ωcm)⁻¹ is referred to as an insulator. Among the fillers described above, scale-like graphite, artificial graphite, and expanded graphite have high electrical conductivity, and hexagonal boron nitride is particularly preferable because it provides a highly thermally conductive material having high insulation properties.

The scale-like graphite is scale-shaped graphite produced mainly from mines in China, the United States, India, Brazil, and the like and having a large aspect ratio, and in general, larger scales are associated with higher heat resistance. Graphite having an average particle size of about 8 to 200 μm, a carbon content of 85 to 99% is frequently sold in the market, and this graphite is anisotropic but has a high thermal conductivity of 200 W/mK or more in the plane direction.

Artificial graphite is a graphite obtained by molding a mixture of powdered cokes and pitch, and artificially developing crystals through a high temperature calcination process at about 3000° C., and this graphite has fewer impurities and high hardness.

Expanded graphite is a graphite obtained by applying heat to acid-treated scale-like graphite to expand graphite crystals between layers to several hundred times. Since expanded graphite has a very low specific gravity while having the characteristics of scale-like graphite, and has fewer impurities, expanded graphite is used as a filler in various fields.

Carbon black is a general term for ultrafine spherical particles obtained by incomplete combustion of various kinds of hydrocarbon or carbon-containing compounds, and among them, one which exhibits high electrical conductivity by filling a polymer material with a small amount is called conductive carbon black. One obtained by thermally decomposing a raw material hydrocarbon by combustion heat of oil or gas is called furnace black, one using acetylene gas is called acetylene black, and one started as a by-product of a gasification process of heavy oil is called ketjen black. There are various forms such as a primary aggregate (aggregate) having a particle size of 0.03 to 0.5 μm in which primary particles having a particle size of 0.001 to 0.1 μm are aggregated, a secondary aggregate (agglomerate) having a particle size of 1 to 100 μm, powdery (loose) particles having a particle size of 50 to 200 μm, and granular (bead) particles having a particle size of 100 to 3000 μm. The particle size described in the present invention refers to a shape which can be dispersed using a solvent and in which the molecular weight distribution can be measured, that is, a particle size of powdery and granular particles.

Hexagonal boron nitride is a white powder having a scale-like crystal structure resembling graphite, and is a chemically stable material called “white graphite”. Hexagonal boron nitride is a material having excellent thermal conductivity, heat resistance, corrosion resistance, electrical insulation properties, and lubricating/mold releasing properties, and is widely used as an additive material in various matrices, and known materials can be used as it is. A scale-like form or a polygonal plate form is generally used, and there are also available aggregate powders in which primary particles are compositely aggregated. Although hexagonal boron nitride is anisotropic, a molded body thereof has a high bulk thermal conductivity of about 60 W/mK.

Examples of the highly thermally conductive filler particles other than the filler particles having a graphite-like structure include aluminum nitride, aluminum oxide (also referred to as alumina), magnesium oxide (also referred to as magnesia), and beryllium oxide (also referred to as beryllia) which are used as highly thermally conductive fillers, ceramics filler particles, which are usually used as isotropic insulating materials, such as crystalline silica and cubic boron nitride, and mixtures thereof, and metal filler particles, which are usually used as conductive materials, such as silver, copper, aluminum, zinc, nickel, iron, tin, and copper alloys, and mixtures thereof. Usually, in the combination of these highly thermally conductive filler particles, it is preferable to use insulating fillers or conductive fillers, because the respective characteristics can be sufficiently exhibited.

Among the highly thermally conductive filler particles, examples of the filler particles having a dielectric constant (εᵣ) of 3.0 to 5.0 and a dielectric loss tangent (tan δ) of 0.00001 to 0.005 corresponding to a high frequency such as 5G or 6G include hexagonal boron nitride (εᵣ=3.3 to 4.5, tan δ=9×10⁻⁴ to 5×10⁻³).

Highly thermally conductive filler particles including lumpy objects having a large particle size are desirably used after being pretreated in advance by pulverization and/or crushing, classification and the like to obtain a desired average particle size. A known method for achieving high thermal conductivity by using highly thermally conductive filler particles having different particle sizes in combination or controlling the shape of the filler particles can be used.

(Preparation Method for Powder Composition)

The powder composition according to the present embodiment includes organic polymer particles and highly thermally conductive filler particles having a thermal conductivity of 10 W/mK or more, and is obtained by uniformly dispersing 5 to 60 wt % of the organic polymer particles and 40 to 95 wt % of the highly thermally conductive filler particles with respect to 100 wt % of the total amount of the organic polymer particles and the highly thermally conductive filler particles using a pulverizer or a mixer. The organic polymer particles include thermoplastic polymer particles formed from a thermoplastic resin and a thermoplastic elastomer including a non-particulate shape and uncured thermosetting resin particles having a non-particulate shape or thermosetting elastomer particles, and the highly thermally conductive filler particles include filler particles having a graphite-like structure and known highly thermally conductive filler particles other than the filler particles.

In the case of a powder composition, which includes organic polymer particles including thermoplastic polymer particles and highly thermally conductive filler particles including a filler having a graphite-like structure, of a preferred embodiment of the present invention, when mixing is performed using too large a force, pulverization occurs, and thus, the surface area of the highly thermally conductive filler particles is significantly increased, so that thermal conduction is inhibited at the particle interface, which is not preferable. Therefore, in the present embodiment, it is preferable to perform mixing by a method of uniformly dispersing the highly thermally conductive filler in the composition while maintaining the average planar particle size of the filler particles having a graphite-like structure. As the mixing method, a method using delamination and/or cohesive fracture of a filler of filler particles having a graphite-like structure is preferable.

As for the proportion of the organic polymer particles and the highly thermally conductive filler particles having a thermal conductivity of 10 W/mK or more in the powder composition used in the present invention, the proportion of the organic polymer particles is 5 to 60 wt % and preferably 10 to 50 wt % with respect to 100 wt % of the total amount of the organic polymer particles and the highly thermally conductive filler particles. The proportion of the highly thermally conductive filler particles is 40 to 95 wt % and preferably 50 to 90 wt %. When the proportion of the organic polymer particles is less than 5 wt % and the proportion of the highly thermally conductive filler particles is more than 95 wt %, it is difficult to cover the periphery of the highly thermally conductive filler particles with the organic polymer particles. When the proportion of the organic polymer particles is more than 60 wt % and the proportion of the highly thermally conductive filler particles is less than 40 wt %, the presence of the organic polymer particles at the interface of the highly thermally conductive filler particles increases, and as a result, the connection between the filler particles is inhibited, and thermal conductive and electrically conductive paths are hardly formed.

The proportion of the thermoplastic polymer particles in the organic polymer particles is preferably 20 wt % or more, more preferably 50 wt % or more, and further preferably 80 wt % or more. The proportion of the filler having a graphite-like structure in the highly thermally conductive filler is preferably 20 wt % or more, more preferably 50 wt % or more, and further preferably 80 wt % or more. This is because when the proportion of each of the thermoplastic polymer particles and the filler having a graphite-like structure is 20 wt % or more, it is possible to improve performance such as thermal conductivity, electrical characteristics, and mechanical strength by morphology control, which is a characteristic of the thermoplastic polymer and the filler having a graphite-like structure, and to perform dichroic molding (joining between different materials) using the thermoplastic polymer.

The proportion of the thermoplastic resin particles in the thermoplastic polymer particles is preferably 20 wt % or more, more preferably 50 wt % or more, and further preferably 80 wt % or more. The proportion of the thermoplastic elastomer including a non-particulate shape is preferably 5 to 80 wt %, more preferably 15 to 50 wt %, and still more preferably 20 to 30 wt %. When the proportion of the thermoplastic resin is 20 wt % or more, it is possible to improve physical properties such as high thermal conductivity, excellent electrical characteristics, and high mechanical strength by morphology control, which is a characteristic of the thermoplastic resin and the filler having a graphite-like structure. When the proportion of the thermoplastic elastomer including a non-particulate shape is 5 wt % or more, it is possible to improve the brittleness of the thermoplastic resin under high filler loading such as performance improvement such as improvement of flexibility to a molded product, improvement of impact resistance, improvement of adhesion and adhesiveness at the interface between different materials by improving surface properties, and improvement of thermal cyclability at a low temperature. When the proportion of the thermoplastic elastomer including a non-particulate shape is 80 wt % or less, it is possible to prevent deterioration in performance such as thermal conductivity, electrical characteristics, and mechanical strength due to conversion of thermal energy or electrical energy into kinetic energy at the elastomer site.

The proportion of the thermosetting elastomer in the organic polymer particles is preferably 2 to 50 wt %, more preferably 5 to 35 wt %, and still more preferably 10 to 20 wt %. The thermosetting elastomer can improve performance such as improvement of flexibility to a molded product, improvement of impact resistance, and improvement of thermal cyclability at a low temperature, and when the proportion of the thermosetting elastomer is 50 wt % or less, it is possible to prevent deterioration in performance such as thermal conductivity, electrical characteristics, and mechanical strength due to conversion of thermal energy or electrical energy into kinetic energy at the elastomer site.

The proportion of the uncured thermosetting resin including a non-particulate shape in the organic polymer particles is preferably 2 to 60 wt %, more preferably 5 to 40 wt %, and still more preferably 10 to 30 wt %. When the proportion of the uncured thermosetting resin including a non-particulate shape is 2 wt % or more, it is possible to improve physical properties such as mechanical strength by penetration of the uncured thermosetting resin having high fluidity into the filler, improvement of adhesion and adhesiveness with a metal foil, and formation of a network polymer by crosslinking. When the proportion of the uncured thermosetting resin including a non-particulate shape is 60 wt % or less, the expression of the above characteristics of the thermoplastic polymer is not significantly inhibited.

Examples of a method of powder mixing the organic polymer particles, the highly thermally conductive filler particles, and the like include a method of introducing the materials into a bag or a can and manually mixing the materials; a mixing method using a tumbler or the like; a method using a powder mixer such as a Henschel mixer, a Super mixer, or a high-speed mixer; and a method using a pulverizer such as a jet mill, an impact mill, an attrition mill, an air classification (ACM) mill, a ball mill, a roller mill, a bead mill, a medium mill, a centrifuge mill, a cone mill, a disc mill, a hammer mill, or a pin mill. Methods combining these methods may be used. The method using a pulverizer is capable of uniform mixing because large forces such as compressive force, shear force, impact force, and frictional force are applied to powder particles, and is capable of micronizing the organic polymer particles and cohesive fracturing the filler, which is preferable in the present invention. However, in the case of using a pulverizer having a large crushing force, special control is required in order to maintain the average planar particle size of the filler particles. In particular, a method using a ball mill, a roller mill, a bead mill, or a medium mill is particularly preferable in that the average planar particle size of the filler particles can be maintained without requiring special control, and relatively soft organic polymer particles can be pulverized and attached to the periphery of the filler particles. On the other hand, when an aggregated type filler is used in combination with a flat filler in order to alleviate anisotropy, in order to prevent cohesive fracture of the aggregated type filler, those obtained by shortening the mixing/pulverizing time of the latter or those obtained by using only a flat filler to prepare a powder composition and then uniformly dispersing the powder composition by a mixing method without pulverization can be used as the powder composition.

In general, a ball mill is a device for producing a powder dispersed by grinding a material adhering to ball surfaces using frictional force or impact force, by introducing hard balls made of a ceramic or the like and powders of materials into a cylindrical vessel, and rotating the vessel. Therefore, since uniform dispersion can be achieved by delamination or cohesive fracture while easily and efficiently maintaining the average planar particle size of the filler particles having a graphite-like structure, the ball mill is preferable. The size or shape of the raw material used for mixing and pulverizing does not need to be particularly strictly controlled. However, it is preferable to use those within a predetermined range in order to maintain the quality.

A particle surface generated by pulverizing the filler particles is activated and is in a highly reactive state. For example, when natural graphite is pulverized under sealing using a vibrating ball mill, different forms of natural graphite are obtained depending on a gas atmosphere. In the presence of an active gas such as oxygen, natural graphite is broken (delaminated) in a cleavable manner to obtain glossy gray graphite in a flaky form. On the other hand, in the presence of an inert gas such as helium, natural graphite is broken in a non-cleavable manner to obtain a three-dimensional pulverized form. In the former, it is considered that the activated particle surface reacts with oxygen to be inactivated, the friction coefficient of graphite decreases, and pulverization due to falling of balls is suppressed. As described above, since the pulverization conditions change depending on the gas atmosphere, attention is required. It is preferable to shorten the pulverization time under such conditions that pulverization is not performed, for example, in the presence of an activated gas such as an oxygen atmosphere or an air atmosphere, or in the presence of an inert gas.

The mixing time under the air atmosphere is preferably 0.2 to 15 hours and more preferably 0.5 to 5 hours. When the mixing time is 0.2 hours or longer, sufficient mixing can be performed, and when the mixing time is shorter than 15 hours, fine pulverization is suppressed, which is preferable.

The average particle size of the uniform powder composition (organic polymer particles and highly thermally conductive filler particles) obtained by pulverization is preferably 0.5 to 500 μm and more preferably 1 to 100 μm. When the average particle size of the composition is 0.5 μm or more, the contact area between the fillers decreases due to a decrease in surface area, and deterioration of thermal conductivity and electrical characteristics due to loss caused by contact can be prevented. On the other hand, when the average particle size of the composition is 500 μm or less, the resin is uniformly dispersed, and it is possible to prevent a decrease in strength due to poor contact between the resin and the filler and deterioration in surface properties due to surface protrusions of the filler. For the measurement of average particle size and particle size distribution of the powder composition, known methods such as a dynamic light scattering method, a laser diffraction method, imaging method using an optical microscope or an electron microscope, a gravity sedimentation method, and a sieving test method can be used.

At this time, the highly thermally conductive filler particles including filler particles having a graphite-like structure according to the present invention are strong against the force in a direction perpendicular to the particle surface in the graphite-like structure, and can maintain the average planar particle size. On the other hand, since the powdery organic polymer particles have a weaker cohesive force in all directions than that of the filler, the powdery organic polymer particles are likely to be refined during pulverization and mixing, have an average particle size equal to or less than the average particle size of the highly thermally conductive filler particles, and may be in a state of covering the periphery of the filler. Therefore, the form of the organic polymer particles is not pellets or flakes, but is preferably a powdery form at the time of polymer production or a form that is easily pulverized at the time of mixing and pulverizing. As for those which are difficult to be pulverized, those pulverized in advance can be used as necessary. In the case of a rubbery material that is hardly pulverized, a rubbery material having been dissolved or dispersed in a solvent can be used by uniformly dispersing the rubbery material around the filler and then removing the solvent.

In the powder composition used in the present invention, known additives, reinforcing agents and/or fillers can be appropriately used as necessary as long as they do not contradict the object of the present invention. Examples of the additives include a mold release agent, a flame retardant, an antioxidant, an emulsifier, a softener, a plasticizer, a surfactant, a coupling agent, a compatibilizer, and the like. By using a coupling agent, particularly a silane coupling agent in combination, that is, treating the filler surface with a silane coupling agent, the affinity at the interface between the filler and the resin can be enhanced, and it is possible to prevent cracking and void generation due to misalignment at the interface between the filler and the resin due to a shear force generated at the interface between the filler and the resin caused by a thermal cycle, vibration, or the like of a copper-clad substrate and a shear force generated at the time of molding the thin sheet.

Examples of the reinforcing materials include short fibers formed from glass fibers, carbon fibers, metal fibers, and inorganic fibers. Examples of other fillers include calcium carbonate (limestone), glass, talc, silica, mica, diamond, carbon black, graphene, and the like. Carbon nanotubes, carbon nanofibers, ceramic nanofibers, and cellulose nanofibers all of which have a fiber diameter of 1 μm or less, and whiskers such as aluminum nitride whiskers, silicon carbide whiskers, silicon nitride whiskers, and whisker-like ceramics such as fibrous basic magnesium oxide are also useful as reinforcing materials. Examples thereof include recycled products obtained by heat-treating used or discarded carbon fibers, and the like. In particular, whisker is obtained by extending particles having a diameter of several μm in a fibrous form, and by using the whisker in combination with a filler having a graphite-like structure, it is possible to enhance thermal conductivity and mechanical properties, to prevent warpage when a copper-clad sheet is produced, and to prevent penetration of an etching solution into a resin phase during etching. Since the present invention contains a thermoplastic resin as a main component, it is possible to effectively reuse an end material of the thin sheet, an out-of-specification product, a molded article of the thin sheet, and the like.

(Supply of Powder Composition)

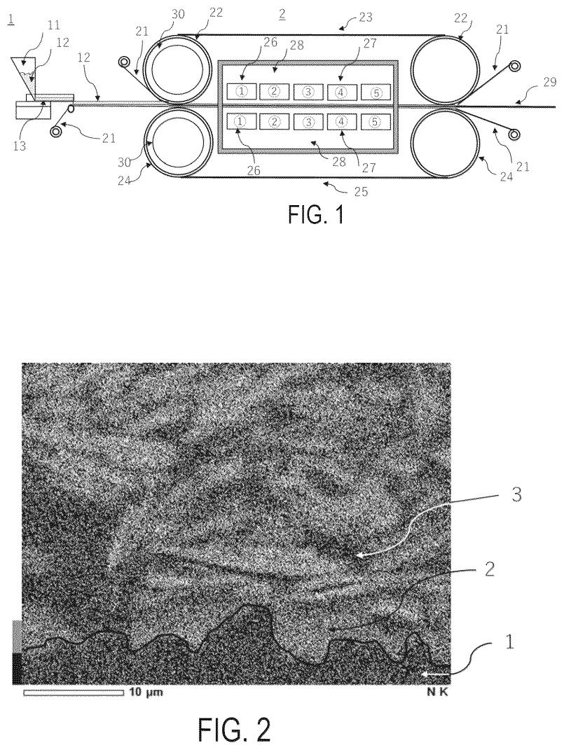

FIG. 1 illustrates an example of a continuous production device including a raw material supply device 1 and a double belt press device 2. The powder composition is supplied to the double belt press device by controlling a powder composition 12 in a hopper 11 so that the powder composition is supplied onto a release film 21 at a constant thickness, usually using a conveying device 13. As a conveying device of making the thickness constant, known methods such as a method using a thickness adjusting plate conventionally used, a method using seeding roller or a covering roller in a seeding machine to control a gap by a slit and adjust a rotation speed of the roller, a method using a vibratory conveying device or a combination of the conveying device and a thickness adjusting plate can be used. Since the thickness of the thin sheet of the present invention is determined by the thickness at the time of supplying the powder composition, it is most important to supply the powder composition at a constant thickness. Therefore, a method using a vibratory conveying device and a thickness adjusting plate in combination is preferable. It is more preferable that after the thickness is made constant with a thickness adjusting plate, light pressurization is further performed using a roll to smooth the sheet surface. When the powder composition is slightly aggregated, it is preferable to convey the powder composition after loosening the aggregation using a vibrating sieve or the like.

(Double Belt Press Device)

As the double belt press device 2, a known device, which includes a first belt 23 made of metal that is wound around a plurality of first driving rollers 22 and circulates, a second belt 25 made of metal that is wound around a plurality of second driving rollers 24 and circulates below the first belt, and a pressurizing device 28 and a heating device 26 (circled number: 1 to 3), or a pressurizing device 28, a heating device 26, and a cooling device 27 (circled number: 4 and 5) that are respectively disposed between the plurality of first driving rollers 22 and between the plurality of second driving rollers 24 in a pressurization region where the first belt 23 and the second belt 25 face each other, can be used. In the present invention, by using such a double belt press device 2, the above-described powder composition is pressurized and heated, or pressurized, heated, cooled, and solidified to produce a high filler-loaded thermally conductive thin sheet 29 having a constant sheet thickness. A heating coil 30 is provided inside the driving rollers 22 and 24 at the inlet of a body to be heated so that heating can be performed.

The pressurizing device for pressurizing the belt can be performed by a known method using a roller and/or a pressurized flowable liquid 28; however, since the method using the roller becomes a linear pressure and concavities and convexities are generated on the sheet surface, it is preferable to use a surface pressure by the flowable liquid in order to smooth the sheet surface. As the heating device for heating the belt, a known method such as a method of directly heating the roller and/or the flowable fluid (pressurized fluid) 28 with an electric heater 30 or a method of heating the flowable fluid (pressurized fluid) 28 and/or the belts 23 and 25 made of metal using a high frequency can be applied. Induction heating using a high frequency is more preferable because an object to be heated can be quickly heated to a high temperature. The double belt press device can expose a body to be heated (powder composition) to a high temperature for a long time by surface heating with a belt, and is a method suitable for forming a powder composition containing a thermoplastic resin having a high melting point and a high softening temperature into a sheet.

The double belt press device can include a known device having a thickness adjustment mechanism for controlling the sheet thickness. For the control of the thickness, in the case of using the powder composition, it is particularly preferable to use a known thickness control device that not only simply controls the thickness of an object to be pressed by a pair of pressing heads by a wedge, but also accurately holds a gap between the pressing heads by causing the pressing force of the object to be pressed to act in a balanced manner on the facing surface of the wedge that holds the gap between the pressing heads constant.

(Pressurization/Heating, Cooling/Solidification, and Conveyance)

Heating and pressurization transfer thermal energy and pressure to the belt using driving rollers, internal rollers, and/or a flowable fluid (pressurized fluid) to transfer the thermal energy and pressure to the powder composition. Heating is performed at a temperature higher than or equal to the deflection temperature under load, melting point, or glass transition temperature of the organic polymer in the powder composition, particularly, of the thermoplastic resin contained in the organic polymer, and pressurization is required to remove air bubbles contained in the powder composition and maintain the sheet shape. Thereafter, a highly thermally conductive thin sheet can be obtained by cooling and solidification. Cooling and solidification are performed by water cooling or oil cooling to cool the powder composition to a temperature equal to or lower than the deflection temperature under load or recrystallization temperature of the thermoplastic resin, preferably a temperature equal to or lower than the glass transition temperature of the thermoplastic resin using a driving roller, an internal roller, and/or a flowable fluid (pressurized fluid) and solidifying the powder composition. Cooling and solidification can be performed in the double belt press device, but can also be performed outside the double belt press device. In order to obtain a sheet with stable quality, it is more preferable to perform cooling and solidification in the double belt press device.

A heating temperature is preferably 120° C. or higher, more preferably 130 to 450° C., and particularly preferably 150 to 400° C. The pressurization is carried out at a pressure of 0.05 to 30 MPa, preferably at a pressure of 0.1 to 15 MPa. When the pressure is 0.05 MPa or more, degassing can be performed, and when the pressure is 30 MPa or less, a thin sheet having a uniform surface can be obtained. In the case of cooling in the double belt press device, the temperature of the thin sheet is preferably equal to or lower than the glass transition temperature of the thermoplastic polymer, particularly, the thermoplastic resin at the time of discharge from the double belt press device. The temperature of the metal belt is not constant, and in consideration of heat balance, heating efficiency, deterioration of the device, and the like, it is effective to have a temperature distribution in which the heating temperature of the belt increases along the traveling direction of the belt and then the belt temperature decreases by cooling.

The conveying of the powder composition in the double belt press device is performed by placing a release film on the belt and moving the powder composition on the film. As the release film, a known film such as a PET film or a polyimide film that withstands heating temperature can be used. The conveying may be performed using one release film on the lower roller, but it is more preferable to convey the powder composition using two upper and lower release films so as to sandwich the powder composition between the release films. If necessary, generation of voids can be further suppressed by vacuuming between the films. In order to improve the peelability, it is more preferable to further apply a release agent resistant to a heating temperature to the film. By using a metal foil film such as a copper foil instead of the release film, a metal foil sheet on one side or both sides can be directly produced.

Copper foils used as semiconductor substrates include rolled copper foils and electrolytic copper foils, and various treatments are performed in order to increase the adhesive strength between the copper foils and the resin. There are a roughening treatment of imparting fine particles made of copper and copper oxide to the surface of a raw copper foil, overlaying plating with copper sulfate for preventing the roughened particles from falling off and improving the adhesion thereof, a heat resistance treatment (barrier layer formation) with brass, zinc, or the like for imparting heat resistance and weather resistance thereon, a prevention treatment such as an electrolytic chromate treatment, and the like, and a silane coupling agent treatment may be performed to further improve the adhesion. In the present invention, these known copper foils can be used. The present invention uses a resin mainly composed of a thermoplastic resin, and is generally poor in adhesiveness to a metal. A known adhesive including a thermosetting resin, a curing agent, and the like can be further applied to the surface of the copper foil to increase the adhesive strength. As the thermosetting resin, the curing agent, and the like, those described in the section of <High filler-loaded thermally conductive thin sheet> can be appropriately used.

The conveyance speed is preferably 0.01 to 5 m/min and more preferably 0.05 to 2 m/min. When the conveyance speed is 0.01 m/min or more, high productivity can be maintained, and when the conveyance speed is 5 m/min or less, heating/cooling and void removal can be sufficiently performed.

(High Filler-Loaded Thermally Conductive Thin Sheet and Copper-Clad Sheet)

As described above, according to the present invention, a high filler-loaded thermally conductive thin sheet is obtained by heating the powder composition under pressure at a temperature higher than or equal to a deflection temperature under load, melting point, or glass transition temperature of the organic polymer in the powder composition and then cooling and solidifying the powder composition. A copper-clad (copper foil) sheet is obtained by using a copper foil instead of the release film.

(High Filler-Loaded Thermally Conductive Thin Sheet Used as Prepreg)

An uncured or semi-cured prepreg-shaped high filler-loaded thermally conductive thin sheet (prepreg sheet) is obtained by melting a powder composition in which the organic polymer particles contain a thermoplastic polymer and an uncured thermosetting resin including a non-particulate shape, and a deflection temperature under load or melting point of the thermoplastic polymer is equal to or lower than a curing temperature of the thermosetting resin, at a heating temperature of the double belt press device that is a temperature higher than or equal to the deflection temperature under load or melting point of the thermoplastic polymer and equal to or lower than the curing temperature of the thermosetting resin, and then cooling and solidifying the powder composition. For example, there is mentioned a powder mixture formed from hexagonal boron nitride as a highly thermally conductive filler, nylon 12 (melting point measured by DSC measurement: 188° C.) as a thermoplastic polymer, a mixture of benzoxazine and bismaleimide at a molar ratio of 25:75 (curing temperature measured by DSC: 213° C.) as a thermosetting resin, and nylon 6 (melting point measured by DSC: 223° C.) or polyphenylene sulfide (melting point measured by DSC: 298° C.) as a resin for a reinforcing material. By adding a known fibrous reinforcing material such as glass cloth or carbon fiber (cloth, nonwoven fabric, or the like) to the sheet, or adding a thermoplastic polymer for reinforcement having a melting point higher than that of the thermoplastic polymer (not melted at the time of forming the sheet) to the powder composition, it is possible to maintain the shape and reinforce the mechanical strength. The prepreg sheet can be formed into a copper-clad sheet by using a copper foil instead of the release film, or can be formed integrally with a copper foil into a copper foil sheet. The copper foil sheet can be finally used as a prepreg layer in the production of a multilayer substrate or as an encapsulating material in the production of a semiconductor device, which is used by being heated to a temperature higher than or equal to the curing temperature of the thermosetting resin.

In the thin sheet described above, by liquefying or softening the organic polymer particles, a liquefying or softening polymer is infiltrated into a gap between one filler particle and the other filler particle, and the A-phase composed only of the organic polymer and the B-phase containing the filler as a main component are entangled to form a three-dimensional network structure composed of the B-phase. Since the concentration of the thermally conductive filler is more than or equal to a percolation threshold, the thermally conductive fillers are in sufficiently close contact with each other at the end surface of the thermally conductive filler, and the thermally conductive filler exists as an infinite cluster spreading over the entire system. When the filler is a flat filler having a graphite-like structure, the surfaces adhere to each other to form a more effective continuous phase. In the cooling/solidification stage, cooling proceeds from the B-phase containing a filler having remarkably high thermal conductivity due to contact with cold air from the outside, and then solidification and/or crystallization of the peripheral polymer occurs, and the entire system is immobilized by effective cooling/solidification around the filler. In press molding, cooling and solidification occur from the pressing direction above and below the mold, but in double belt pressing, cooling and solidification occur from the side surface perpendicular to the conveyance direction, and it can be expected that the organic polymer is crystallized or solidified, the orientation of the flat filler having a graphite-like structure exhibiting anisotropy is dominant, and the thermal conductivity in the vertical direction is increased.

The “infinite cluster” is based on the percolation conduction theory, and in general, the “percolation theory” is a theory that targets how target substances are connected in a system and how the characteristics are reflected in the properties of the system. Specifically, when the fillers are sufficiently in contact with each other and the concentration reaches a percolation (permeation) threshold, the conductive fillers aggregate at a specific concentration (threshold) or more of the conductive fillers, and a cluster (infinite cluster) in which the entire system is continuous is formed. In this way, electrical conductivity is developed throughout the system.

In the present invention, characteristics such as crystallinity and compatibility of the organic polymer interposed around the thermally conductive filler particularly greatly affect not only electrical conductivity but also thermal conductivity and thermal expansion. The percolation threshold depends on the concentration and shape of the thermally conductive filler, the mixed state with the organic polymer particles, and the bonding state between the thermally conductive fillers. However, the electrical conductivity is more strongly affected by the shape of the filler and the polarity of the resin than the thermal conductivity, and thus, the electrical conductivity is more sensitive to a change in morphology.

In the present embodiment, the powder composition has a condition that a thermally conductive infinite cluster is formed, and the condition can be realized by controlling the content of the organic polymer particles and the thermally conductive filler in the powder composition, and the uniform dispersibility, shape, morphology, and the like of each component.

Whether or not the powder composition according to the present embodiment has a condition that an infinite cluster is formed is determined as follows. That is, it can be confirmed by preparing a test piece from a high filler-loaded thermally conductive thin sheet or preparing a molded product by a method using a conventional heat press machine, measuring the thermal conductivity of the test piece or the molded product or measuring the electrical conductivity in the case of a conductive material, and observing the filler concentration (percolation threshold) at which the value of the thermal conductivity or the electrical conductivity rapidly increases in relation to the filler concentration. The molded product test piece is directly observed using a scanning electron microscope (SEM), a transmission electron microscope (TEM), and/or energy dispersive X-ray spectroscopy (EDX), and it can also be determined whether or not the fillers are in close contact with each other to form a continuous phase.

Since there is almost no loss in molding processing regarding the main constituent components and the used amounts in the powder composition, it can be estimated by chemical analysis such as elemental analysis, infrared absorption spectrum, nuclear magnetic resonance spectrum, GC-MS spectrum, and the like of the thin sheet. The concentration of a non-flammable filler such as ceramics is obtained by performing thermogravimetric (TG) analysis of the thin sheet in the presence of oxygen to burn the organic polymer and determining the residue.

(Reprocessed High Filler-Loaded Thermally Conductive Thin Sheet)

The high filler-loaded thermally conductive thin sheet obtained as described above is heated and pressurized again at a temperature higher than or equal to a deflection temperature under load, melting point, or glass transition temperature of the organic polymer and at a pressure of 0.05 or more using the double belt press device of the present invention and the known heat roll press device and heat press device, and then cooled and solidified, that is, the high filler-loaded thermally conductive thin sheet is reprocessed, whereby the quality of the high filler-loaded thermally conductive thin sheet such as uniformization of the sheet thickness, removal of fine cracks affecting gas impermeability, and improvement of surface properties can be achieved. Among these, a method using a double belt press device and a heat roll press device is particularly preferable because of high productivity.

<Production Method for High Filler-Loaded Thermally Conductive Thin Sheet>

According to another embodiment of the present invention, there is provided a production method for a high filler-loaded thermally conductive thin sheet, including:
a step (1) of preparing a powder composition including organic polymer particles containing a thermoplastic polymer and a highly thermally conductive filler having a thermal conductivity of 10 W/mK or more, the powder composition having conditions that 5 to 60 wt % of the organic polymer particles and 40 to 95 wt % of the highly thermally conductive filler with respect to 100 wt % of the total amount of the organic polymer particles and the highly thermally conductive filler particles are uniformly dispersed using a pulverizer or a mixer, a thermally conductive infinite cluster is formed, and a concentration of the thermally conductive filler is more than or equal to a percolation threshold;
a step (2) of conveying, using a conveying device, the powder composition at a constant thickness between a first belt and a second belt of a double belt press device, the double belt press device including the first belt made of metal that is wound around a plurality of first driving rollers and circulates, the second belt made of metal that is wound around a plurality of second driving rollers and circulates below the first belt, and a pressurizing device and a heating device, or a pressurizing device, a heating device, and a cooling device that are respectively disposed between the plurality of first driving rollers and between the plurality of second driving rollers in a pressurization region where the first belt and the second belt face each other; and
a step (3) of continuously heating and pressurizing the powder composition conveyed at a constant thickness at a temperature higher than or equal to a deflection temperature under load, melting point, or glass transition temperature of the organic polymer and at a pressure of 0.5 to 30 MPa and then cooling and solidifying the powder composition in the double belt press device.

In the step (1) of preparing a powder composition, the step (2) of conveying the powder composition, and the step (3) of heating, pressurizing, cooling, and solidifying the powder composition in the production method for a high filler-loaded thermally conductive thin sheet, the method described in the section of <High filler-loaded thermally conductive thin sheet> is appropriately adopted.

There is also provided a production method for a reprocessed high filler-loaded thermally conductive thin sheet, including heating and pressurizing the thin sheet obtained by the above-described production method at a temperature higher than or equal to the deflection temperature under load, melting point, or glass transition temperature of the organic polymer and at a pressure of 0.05 MPa or more and then cooling and solidifying the high filler-loaded thermally conductive thin sheet in at least one device selected from the group consisting of the double belt press device, a roll press device, and a heat press device.

<Production Device for High Filler-Loaded Thermally Conductive Thin Sheet>

According to still another embodiment of the present invention, there is also provided a production device for a high filler-loaded thermally conductive thin sheet for use in the production method described above. The production device includes a double belt press device including a first belt made of metal that is wound around a plurality of first driving rollers and circulates, a second belt made of metal that is wound around a plurality of second driving rollers and circulates below the first belt, and a pressurizing device and a heating device, or a pressurizing device, a heating device, and a cooling device that are respectively disposed between the plurality of first driving rollers and between the plurality of second driving rollers in a pressurization region where the first belt and the second belt below the first belt face each other; and
a conveying device for conveying the powder composition at a constant thickness between the first belt and the second belt.

As the device of conveying the powder composition and the heating, pressurizing, cooling, and solidifying device in the production device for a high filler-loaded thermally conductive thin sheet, the devices described in the section of <High filler-loaded thermally conductive thin sheet> are appropriately adopted.

<Molded Article of High Filler-Loaded Thermally Conductive Thin Sheet>

According to still another embodiment of the present invention, the above-described high filler-loaded thermally conductive thin sheet or a thin sheet obtained by the production method or production device for a high filler-loaded thermally conductive thin sheet can be used as a molded article. This molded article is preferably used as an electrical or electronic component because the molded article is excellent in electrical characteristics in terms of insulation properties or electrical conductivity, and thermal conductivity. For the molded article, the method described in the section of <High filler-loaded thermally conductive thin sheet> is appropriately adopted.

The molded article of the high filler-loaded thermally conductive thin sheet according to the present invention is obtained by cutting, cutting machining, or heat pressing using a mold, and molded into various shapes. An insulating sheet using an insulating filler such as a ceramic filler can be used for electrical or electronic components that significantly generate heat due to high performance and miniaturization, such as thermal interface materials (TIM: core material and prepreg) for power devices such as Si, SiC, GaN, and Ga₂O₃ and copper-clad substrates thereof, multilayer substrates including a core layer and a prepreg layer, sealing materials in power devices, LED backlights, high-brightness LED substrates, and casings of next-generation smartphones. By combining a low dielectric constant-low dielectric loss tangent filler with an organic polymer, the obtained material can also be used as a high-frequency compatible member or component for 5G, 6G, or the like.

On the other hand, a conductive sheet using a conductive filler such as a graphite filler can be used as, for example, a fuel cell separator by forming a flow path using a cutting machine or a heat press device. As a conductive sheet other than the fuel cell separator, the conductive sheet can be further used for casing of electrical or electronic components, electrode materials of lithium ion secondary batteries, current collectors of all resin batteries, and the like, and further can be used for reinforcing a thin insulating sheet without impairing heat dissipation characteristics by dichroic molding with the insulating sheet. In particular, in terms of strength and durability which are disadvantages of a resin separator, by combining the resin separator with a metal separator, advantages of both the resin separator and the metal separator can be utilized and disadvantages can be compensated, which can contribute to cost reduction and weight reduction. Since the thin sheet of the present invention has a larger heat capacity (specific heat) than metals, rapid heat generation and the like can be alleviated.

In order to improve energy conversion efficiency, a material having a low resistance value and a low contact resistance value in the penetrating direction is required as electrical characteristics of a separator for a polymer electrolyte fuel cell, and the contact resistance value is preferably 10 mΩcm² or less. As a TIM (thermally conductive insulating material) for a power device, a material having a high thermal conductivity, a high dielectric breakdown voltage value at which high voltage can be used, and excellent adhesiveness with a metal such as a copper foil is required, and the dielectric breakdown voltage value is preferably 15 kV/mm or more for a high-output power device. In both cases, not only the electrical characteristics of the material itself, but also the electrical conductivity (contact resistance) at the interface between different materials in the former case, and the presence of voids and cracks in the material in the latter case are problematic.

### EXAMPLES

Hereinafter, the present invention will be specifically described with reference to Examples, Comparative Examples, and Reference Examples, but the scope of the present invention is not limited thereto. Note that, production and evaluation of raw materials, powder compositions, thin sheets, and molded articles were carried out as follows.

(1) Raw Materials

[Thermoplastic Resin]

Polyphenylene sulfide (PPS) particles: W203A NATURAL manufactured by KUREHA CORPORATION, white powder, linear form, particle size 100 to 500 μm, specific gravity 1.35, melting point 294° C. (DSC measurement), recrystallization temperature 226° C. (DSC measurement)
Nylon 6 (PA6) particles: manufactured by Ube Industries, Ltd., white powder, average particle size 150 μm, melting point 223° C. (DSC measurement), recrystallization temperature 183° C. (DSC measurement)
Polyether ether ketone (PEEK) particles: VESTAKEEP 4000FP manufactured by Daicel-Evonik Ltd., white powder, crystalline, average particle size 65 μm, specific gravity 1.30, melting point 340° C. (catalog data), glass transition temperature 140° C. (catalog data)
Heat-resistant thermoplastic polyimide particles: AURUM PD450 manufactured by Mitsui Chemicals, Inc., yellow powder, amorphous, average particle size 20 μm, specific gravity 1.33, melting point 388° C. (catalog data), glass transition temperature 245° C. (catalog data)
Copolymer (PFA) particles of tetrafluoroethylene and perfluoroalkyl vinyl ether: NEOFLON PFA AP-201 manufactured by DAIKIN INDUSTRIES, Ltd., white pellet, crystalline, specific gravity 2.15, melting point 303° C. (catalog data), glass transition temperature 85° C. (catalog data), using one pulverized to a particle size of about 200 μm or less by a pulverizer
Polyphenylene ether (PPE) particles: XYRON manufactured by Asahi Kasei Corp., white powder, amorphous, average particle size 200 to 400 μm, specific gravity 1.06, glass transition temperature 214° C. (catalog data)
Syndiotactic polystyrene (SPS) particles: XAREC 5105 (kneaded product of 70 mass % of SPS and 30 mass % of elastomer having good solubility) manufactured by Idemitsu Kosan Co., Ltd., white pellet, crystalline, specific gravity 1.02, melting point 278° C. (DSC data), glass transition point 104° C. (DSC data), using one pulverized to a particle size of about 200 μm or less by a pulverizer

[Uncured Thermosetting Resin (Precursor)]
P-d type benzoxazine resin: P-d type benzoxazine manufactured by SHIKOKU CHEMICALS CORPORATION, yellow powder, particle size 0.01 to 0.1 mm (SEM observation), melting point 75° C. (DSC measurement), exothermic curing peak temperature 241° C. (DSC measurement)
Bismaleimide resin: N,N′-(4,4′-diphenylmethane)bismaleimide manufactured by KI Chemical Industry Co., LTD., light-yellow-brown granulated, melting point 162° C. (DSC measurement)
Phenolic epoxy resin A: manufactured by DIC Corporation, phenol novolac type, epoxy equivalent 190 g/eq, softening point 70° C., a lumpy object was crushed and used as a granular product
Phenolic epoxy resin B: manufactured by DIC Corporation, bisphenol F type, epoxy equivalent 171 g/eq, viscous liquid (viscosity 3,500 mPas (25° C.))

[Thermoplastic Elastomer (Modifier)]
Nylon 12 (PA12) particles: manufactured by Daicel-Evonik Ltd., white powder, average particle size 45 μm, melting point 188° C. (DSC measurement), recrystallization temperature 138° C. (DSC measurement), specific gravity 1.02
SEBS particles: Tuftec M1913 manufactured by Asahi Kasei Corp., specific gravity 0.92, styrene/ethylene-butylene ratio 30/70, acid value 10 mg CH₃ONa/g, a pellet was pulverized by a pulverizer and used.
Fluorine-based thermoplastic elastomer particles: DAI-EL T-530 manufactured by DAIKIN INDUSTRIES, Ltd., translucent pellet, amorphous, specific gravity 1.89, melting point 230° C. (DSC data), a pellet was pulverized by a pulverizer and used.

[Conductive Filler]
Scale-like graphite: BF-40K manufactured by Chuetsu Graphite Works Co., Ltd., scale-like black powder, average particle size 40 μm, bulk thermal conductivity 150 to 200 W/mK (anisotropic filler: 200 to 600 W/mK in plane direction, 5 to 12 W/mK in thickness direction)
Expanded graphite: CMX-40 manufactured by Nippon Graphite Industries, Co., Ltd., scale-like black powder, average particle size 45 μm, apparent density 0.05 g/cm 3
Graphite scraps: graphite scraps for electrodes manufactured by Showa Denko K.K., particle size 10 to 300 μm (SEM observation)
Aggregated type (spheroidized) graphite: CGB-60R manufactured by Nippon Graphite Industries, Co., Ltd., spherical black powder, average particle size 60 μm, apparent density 0.55 g/cm 3

[Insulating Filler]
Hexagonal boron nitride: hexagonal boron nitride simple grain type UHP-2 manufactured by Showa Denko K.K., white powder, average particle size 9 to 12 μm, bulk thermal conductivity 60 W/mK (anisotropic filler: 200 W/mK in plane direction; 60 W/mK in depth direction)
Aggregated type hexagonal boron nitride: HP-40MF100 manufactured by Mizushima Ferroalloy Co., Ltd., white powder, average particle size 40 μm

[Whisker-Like Ceramics]
Fibrous basic magnesium oxide: fibrous basic magnesium sulfate “MOS-HIGE” manufactured by Ube Material Industries, Ltd., powdery white, fiber length 8 to 30 μm (catalog data), fiber diameter 0.5 to 1.0 μm (catalog data), true specific gravity 2.3, pH 9.5

[Copper Foil]
General electrolytic copper foil: CF-TBG-UN-35 manufactured by FUKUDA METAL FOIL & POWDER CO., LTD., thickness μm, surface roughness Rz of roughened surface=10 μm

(2) Evaluation Method Common to Conductive and Insulating Thin Sheets

[Measurement of Sheet Thickness]
A thin sheet and a press-molded product were cut into a size of 300 mm in length×600 mm in width, six places at equal intervals were determined as measurement places, the film thickness was measured with a micrometer, and the average value and standard deviation of the film thickness were determined as variations in the film thickness.

[Measurement of Thermal Conductivity]
Hot disc method: Measurement was performed using a thermal property analyzer by a hot disc method (TPS2500S manufactured by KYOTO ELECTRONICS MANUFACTURING CO., LTD.). The hot disc method is a method of measuring a thermal conductivity (W/mK) in the vicinity of a surface of a test piece having a certain depth while keeping in mind that heat generated from a hot disc sensor is transferred in a test piece of 40 mm×40 mm in length and width and the measurement is performed in a range where the heat does not reach an end of the test piece. In the case of an anisotropic material, the thermal conductivity in the plane direction perpendicular to the pressing direction can be measured. In the case of a thin sheet, a test piece thermally fused to have a thickness of about 10 mm was used.
Temperature gradient (steady state) method: a test piece was sandwiched between aluminum blocks, one of the aluminum blocks was heated with a constant amount of heat from a ceramic heater, the other was cooled with water at 25° C. to tilt the temperature, a thermal resistance (R=ΔT/Q) was determined from a steady heat flow (Q) and a temperature difference (ΔT) between both ends in the heat flow direction of the test piece of 40 mm×40 mm in length and width (area S), and a thermal conductivity λ (W/mK) was calculated from a plot gradient (ΔR/Δd) with respect to a test piece thickness (d) according to Formula (1).

(1/λ)=S×(ΔR/Δd) (1)

In the case of an anisotropic material, the thermal conductivity in the depth direction which is the pressing direction can be measured. The thickness of the test piece was measured in several points by fusing thin sheets together.

[Measurement of Electrical Conductivity]
Surface electrical conductivity of conductive material: an electrical conductivity ((Ωcm)⁻¹) of the surface of the test piece was measured in accordance with JIS K7194 (1994) using a low resistivity meter, Loresta GP (four-point probe method) manufactured by Nittoseiko Analytech Co., Ltd. The measurement range is 10⁻³ to 10⁷Ω.

Electrical conductivity of insulating material: an electrical conductivity ((Ωcm)⁻¹) of the surface and cross-section of the test piece was measured in accordance with JIS K6911 (1995) using a high resistivity measuring device, Hiresta UX manufactured by Nihon Denkei Co., Ltd. The measurement range is 10⁴ to 10¹⁴Ω.

[Tensile Test]

A dumbbell-shaped test piece having a total length of 170 mm, a parallel part length of 40 mm, and a parallel part width of 10 mm was prepared using SUPER DUMBBELL CUTTER Model SDK-600 manufactured by DUMBBELL CO., LTD., and the tensile strength (MPa), the tensile elastic modulus (GPa), and the elongation rate (%) were determined in accordance with JIS K7161 using a universal tester, Autograph AGX-50 kN plus manufactured by SHIMADZU CORPORATION.

[TG Analysis (Measurement of 5% Decomposition Temperature)]

For the powder composition and the thin sheet, a thermogravimetric change from room temperature to 1000° C. was measured at a heating temperature of 10° C./min in a nitrogen atmosphere using a thermogravimetric analyzer TG/DTA DTG-60 manufactured by SHIMADZU CORPORATION, and the temperature (° C.) at which the weight decreased by 5% was taken as a 5% decomposition temperature (° C.), which was used as an index of heat resistance.

[DSC Analysis (Measurement of Melting Point, Recrystallization Temperature, and Curing Exothermic Peak Temperature)]

For the powder composition and the thin sheet, an endothermic peak temperature (melting point) and a curing exothermic peak temperature of the organic polymer particles were measured at a heating rate of 10° C./min in a nitrogen atmosphere using a differential scanning calorimeter (DSC-60A Plus) manufactured by SHIMADZU CORPORATION, and then cooling was performed to determine the recrystallization temperature.

[Sem/Edx Analysis]

Using a scanning electron microscope (SEM) JSM-IT100 manufactured by JEOL Ltd., the molded product subjected to hub polishing in advance was subjected to SEM/EDX analysis under the conditions of sputter deposition (Pt (5 nm)) and an acceleration voltage of 10 kV.

[Liquid Penetrant Test (Presence or Absence of Liquid Penetration)]

After a red permeation liquid was permeated into cracks (defects) from one side of a thin sheet of 5 cm in length×10 cm in width by capillary action, whether or not the red color floated on the opposite surface to which the white fine powder was applied was observed and evaluated by └ (not at all), ∘ (none), ♦ (nslight), and x (quite visible).

(3) Evaluation Method of Conductive Thin Sheet

[Contact Resistance Value Measurement]

The contact resistance value was measured using a resistance measuring device A0240 manufactured by Imoto Machinery Co., Ltd. including a pressurizer, a gold-plated copper electrode, and a digital tester. Both surfaces of a thin sheet of 2 cm in length×2 cm in width were sandwiched between carbon paper (SIGRACET (registered trademark) GDL (basis weight 38 g/m³, thickness 140 μm) manufactured by SGL Carbon Japan Ltd., and the thin sheet was placed between the electrodes (area 0.7853 cm 2) formed of a cylinder having a diameter of 1 cm. In a state where a surface pressure of 1.0 MPa was applied in the vertical direction and a direct current of 1 ampere was caused to flow between the electrodes by a constant current device, the voltage between the electrodes was read using a multimeter manufactured by KIKUSUI ELECTRONICS CORP., and the electrical resistance value (R₁: electrical resistance value in the penetrating direction) between the electrode/carbon paper/thin sheet/carbon paper/electrode was measured by a four-terminal method.

The contact resistance value was determined by the following Formula (2) as a contact resistance (R) between a thin sheet (Sam) and carbon paper (CP) with regarding CP as a gas diffusion layer for a fuel cell (see JP 2012-82446 A).

R=(R₁+R₂−2×R₃)×S/2=R[CP-Sam]+r[Sam]+r[CP] (2)

R₂ is the electrical resistance value (10.4 mΩcm²) between the electrode/CP/CP/CP/electrode, and R₃ is the electrical resistance value (7.2 mΩcm²) between the electrode/CP/CP/electrode. R[CP-Sam], r[Sam], and r[CP] are the true contact resistance value between (Sam) and CP, and the bulk electrical resistance value of Sam and CP themselves, respectively. When the sheet thickness is considerably thin, the resistance of the bulk can be ignored.

(4) Analysis of Insulating Thin Sheet

[Dielectric Breakdown Voltage Measurement]

A sheet-shaped test piece of 10 mm in length×10 mm in width was prepared and immersed in oil, and the dielectric breakdown voltage at room temperature was measured using an ultra-high voltage withstand voltage tester 7470 (electrode specified in JIS C2110 (spherical shape with 920 and cylindrical shape with 925) manufactured by KEISOKU GIKEN Co., Ltd. In the measurement, the test piece was sandwiched between spherical electrodes having a diameter of 20 mm, and energization was performed under the conditions of a boost speed of 500 V/s, an alternating current of 50 Hz, and a cutoff current of 10 mA until dielectric breakdown occurred, thereby determining a dielectric breakdown voltage (kV/mm).

[Measurement of Dielectric Constant and Dielectric Loss Tangent]

In accordance with JIS C2138, the measurement frequency was 1 MHz, the electrode dimensions were a main electrode diameter of φ36 mm and an annular electrode inner diameter of φ38 mm, the electrode material was a tin foil, and the electrode was attached to the measurement sample using white petrolatum. The number of times of measurement was n=2. Before the measurement, the sample was left to stand still for 24 hours in an atmosphere of 23° C.±1° C. and 50% RH±5% RH in advance to adjust the state. The test was performed in an atmosphere of 23° C.±1° C. and 50% RH±5% RH, and the device used was Precision LCR Meter E4980JIS manufactured by Agilent Technologies, Inc.

[Peel Test]

In accordance with JIS C6481, the copper foil was processed to have a width of 10 mm, an end of the copper foil was peeled off from the sample using a universal tester Autograph AGX-50 kN plus manufactured by SHIMADZU CORPORATION, the copper foil was fixed to a tester gripper and a jig so that the pulled copper foil was perpendicular to the sample, and the copper foil was peeled off by about 50 mm at a speed of 50 mm/min. The peeling strength was calculated from the average value of the loads and the width dimension of the copper foil obtained at that time, and the average value obtained when measurement was performed three times was taken as an adhesive strength.

### Reference Examples 1 to 31 and Comparative Reference Examples 1 and 2 (Production of Powder Composition)

Conductive and insulating highly thermally conductive filler particles, organic polymer particles formed from a thermoplastic resin, a thermoplastic elastomer including a non-particulate shape, and an uncured thermosetting resin, and additives were accurately weighed so as to be weight percentage in Tables 1 and 2, placed in a magnetic pot of a tabletop ball mill BM-10 (manufactured by Seiwa Giken Co., Ltd.), the ball mill was sealed under an air atmosphere using magnetic balls, and pulverized and mixed at room temperature for 4 hours to obtain uniform powder compositions, which were used as Reference Examples 1 to 31 and Comparative Reference Examples 1 and 2. The composition of the conductive powder composition is shown in Table 1, and the composition of the insulating powder composition is shown in Table 2. However, 75 wt % of scale-like graphite in Reference Example 3 was changed to 37.5 wt %, 65 wt % of boron nitride in Reference Example 27 was changed to 16.2 wt %, these materials were pulverized and mixed in advance in the same manner as described above, and then 37.5 wt % of aggregated type scale-like graphite and 48.8 wt % of aggregated type boron nitride were respectively added and uniformly mixed so that the aggregated state was not broken. These obtained materials were used as Reference Examples 17 and 29, respectively.

TABLE 1

| | Reference Example and Comparative Reference Example | | | | | | | | | | | | | | | | | | |
|---|---|---|---|---|---|---|---|---|---|---|---|---|---|---|---|---|---|---|---|
| | | | | | | | | | | | | | | | | | | Comparative | |
| | | | | | | | | | | | | | | | | | | Reference | |
| | Reference Example | | | | | | | | | | | | | | | | | Example | |
| | 1 | 2 | 3 | 4 | 5 | 6 | 7 | 8 | 9 | 10 | 11 | 12 | 13 | 14 | 15 | 16 | 17 | 1 | 2 |
| Highly thermally | | | | | | | | | | | | | | | | | | | |
| conductive filler particles | | | | | | | | | | | | | | | | | | | |
| Scale-like graphite (wt %) | 55 | 65 | 75 | 85 | 50 | 75 | 75 | 75 | 75 | 75 | 75 | 75 | 75 | 75 | 75 | 37.5 | 37.5 | 30 | 95 |
| Graphite scraps (wt %) | 0 | 0 | 0 | 0 | 25 | 0 | 0 | 0 | 0 | 0 | 0 | 0 | 0 | 0 | 0 | 0 | 0 | 0 | 0 |
| Expanded graphite (wt %) | 0 | 0 | 0 | 0 | 0 | 0 | 0 | 0 | 0 | 0 | 0 | 0 | 0 | 0 | 0 | 37.5 | 0 | 0 | 0 |
| Scale-like graphite aggregate (wt %) | 0 | 0 | 0 | 0 | 0 | 0 | 0 | 0 | 0 | 0 | 0 | 0 | 0 | 0 | 0 | 0 | 37.5 | 0 | 0 |
| Organic polymer particles | | | | | | | | | | | | | | | | | | | |
| Thermoplastic resin | | | | | | | | | | | | | | | | | | | |
| PPS resin (wt %) | 45 | 35 | 25 | 15 | 25 | 20 | 15 | 5 | 15 | 12.5 | 12.5 | 12.5 | 0 | 0 | 0 | 0 | 25 | 70 | 15 |
| Nylon 6 resin (wt %) | 0 | 0 | 0 | 0 | 0 | 0 | 0 | 0 | 0 | 0 | 0 | 0 | 15 | 12.5 | 12.5 | 0 | 0 | 0 | 0 |
| Heat-resistant thermoplastic polyimide | 0 | 0 | 0 | 0 | 0 | 0 | 0 | 0 | 0 | 0 | 0 | 0 | 0 | 0 | 0 | 25 | 0 | 0 | 0 |
| (wt %) | | | | | | | | | | | | | | | | | | | |
| Thermoplastic elastomer (modifier) | | | | | | | | | | | | | | | | | | | |
| Nylon 12 resin (wt %) | 0 | 0 | 0 | 0 | 0 | 5 | 10 | 20 | 0 | 8.33 | 8.33 | 8.33 | 0 | 0 | 0 | 0 | 0 | 0 | 0 |
| Hydrogenated SBS resin (wt %) | 0 | 0 | 0 | 0 | 0 | 0 | 0 | 0 | 10 | 0 | 0 | 0 | 10 | 8.33 | 8.33 | 0 | 0 | 0 | 0 |
| Uncured thermosetting resin (wt %) | | | | | | | | | | | | | | | | | | | |
| Benzoxazine resin (wt %) | 0 | 0 | 0 | 0 | 0 | 0 | 0 | 0 | 0 | 4.17 | 2.08 | 1.25 | 0 | 2.08 | 1.25 | 0 | 0 | 0 | 0 |
| Bismaleimide resin (wt %) | 0 | 0 | 0 | 0 | 0 | 0 | 0 | 0 | 0 | 0 | 2.08 | 1.25 | 0 | 2.08 | 1.25 | 0 | 0 | 0 | 0 |
| Phenolic epoxy resin A | 0 | 0 | 0 | 0 | 0 | 0 | 0 | 0 | 0 | 0 | 0 | 1.67 | 0 | 0 | 1.67 | 0 | 0 | 0 | 0 |

TABLE 2

| Reference Example | 18 | 19 | 20 | 21 | 22 | 23 | 24 | 25 | 26 | 27 | 28 | 29 | 30 | 31 |
|---|---|---|---|---|---|---|---|---|---|---|---|---|---|---|
| Highly thermally conductive filler particles | | | | | | | | | | | | | | |
| Boron nitride (wt %) | 55 | 65 | 75 | 75 | 75 | 75 | 65 | 65 | 65 | 65 | 65 | 16.2 | 65 | 65 |
| Boron nitride aggregate (wt %) | 0 | 0 | 0 | 0 | 0 | 0 | 0 | 0 | 0 | 0 | 0 | 48.8 | 0 | 0 |
| Organic polymer particles | | | | | | | | | | | | | | |
| Thermoplastic polymer particles | | | | | | | | | | | | | | |
| PPS resin (wt %) | 45 | 35 | 25 | 12.5 | 12.5 | 12.5 | 17.5 | 17.5 | 15 | 0 | 0 | 15 | 0 | 30 |
| PEEK resin (wt %) | 0 | 0 | 0 | 0 | 0 | 0 | 0 | 0 | 0 | 35 | 0 | 0 | 0 | 0 |
| PFA resin (wt %) | 0 | 0 | 0 | 0 | 0 | 0 | 0 | 0 | 0 | 0 | 30 | 0 | 0 | 0 |
| PPE resin (wt %) | 0 | 0 | 0 | 0 | 0 | 0 | 0 | 17.5 | 15 | 0 | 0 | 15 | 17.5 | 0 |
| SPS resin (wt %) | 0 | 0 | 0 | 0 | 0 | 0 | 0 | 0 | 0 | 0 | 0 | 0 | 17.5 | 0 |
| Thermoplastic elastomer (modifier) | | | | | | | | | | | | | | |
| Nylon 12 resin (wt %) | 0 | 0 | 0 | 8.33 | 8.33 | 8.33 | 11.66 | 0 | 5 | 0 | 0 | 5 | 0 | 0 |
| Hydrogenated SBS resin (wt %) | 0 | 0 | 0 | 0 | 0 | 0 | 0 | 0 | 0 | 0 | 0 | 0 | 0 | 0 |
| Fluorine-based thermoplastic elastomer (wt %) | 0 | 0 | 0 | 0 | 0 | 0 | 0 | 0 | 0 | 0 | 5 | 0 | 0 | 0 |
| Uncured thermosetting resin (wt %) | | | | | | | | | | | | | | |
| Benzoxazine resin (wt %) | 0 | 0 | 0 | 1.25 | 1.25 | 0.83 | 1.17 | 0 | 0 | 0 | 0 | 0 | 0 | 0 |
| Bismaleimide resin (wt %) | 0 | 0 | 0 | 1.25 | 1.25 | 3.34 | 4.67 | 0 | 0 | 0 | 0 | 0 | 0 | 0 |
| Phenolic epoxy resin A (wt %) | 0 | 0 | 0 | 1.67 | 0 | 0 | 0 | 0 | 0 | 0 | 0 | 0 | 0 | 0 |
| Additive | | | | | | | | | | | | | | |
| Phenolic epoxy resin B (wt %) | 0 | 0 | 0 | 0 | 1.67 | 0 | 0 | 0 | 0 | 0 | 0 | 0 | 0 | 0 |
| Fibrous basic magnesium oxide (wt %) | 0 | 0 | 0 | 0 | 0 | 0 | 0 | 0 | 0 | 0 | 0 | 0 | 0 | 5 |

### Examples 1 to 17 (Influence of Type and Concentration of Filler Particles and Organic Polymer Particles in Production of Conductive Thin Sheet)

The conductive powder composition shown in each of Reference Examples 1 to 17 was uniformly spread in a 300 mm long×600 mm wide mold frame placed on a heat-resistant polyimide release film so that the thickness of the conductive thin sheet reached the target sheet thickness shown in Table 3, the mold frame was removed, and then a heated body sample covering the release film was prepared thereon. At this time, the sheet thickness varies depending on how the powder composition is spread, and thus it is necessary to perform the treatment carefully. The heated body sample was passed between a pair of metal double belts of a double belt press device (belt width 600 mm) manufactured by Morita Giken Inc. equipped with an IH induction heating device, a sheet thickness adjustment mechanism, and a plurality of pressure heating/pressure cooling devices, pressurized, heated, and melted under the operation conditions of the pressure, the heating set maximum temperature, and the conveyance speed shown in Table 3, and then pressurized, cooled, and solidified to semi-continuously prepare conductive thin sheets of Examples 1 to 17. The heating set maximum temperature is the maximum temperature of a steel belt at the heating central portion in the conveyance direction measured when the thin sheet and the release film are not present, and has a temperature distribution in which the temperature rises from the driving roller at the inlet toward the central portion.

Measurement of the sheet thickness at six places of each conductive thin sheet obtained as Examples 1 to 17, a thermal conductivity test, an electrical conductivity test, a tensile test, and TG analysis were performed to examine the influence of the type and concentration of the highly thermally conductive filler and the type and concentration of the organic polymer. The results are shown in Table 3.

### Comparative Examples 1 and 2 (Influence of Filler Concentration in Production of Conductive Thin Sheet)

The procedures were carried out in the same manner as in Example 3, except that the conductive powder composition of each of Comparative Reference Examples 1 and 2 was used. The results are shown in Table 3 as Comparative Examples 1 and 2.

TABLE 3

| | | Example and Comparative Example | | | | | | | | | | |
|---|---|---|---|---|---|---|---|---|---|---|---|---|
| | | Example | | | | | | | | | | |
| | | 1 | 2 | 3 | 4 | 5 | 6 | 7 | 8 | 9 | 10 | 11 |
| | | Reference Example and Comparative Reference Example | | | | | | | | | | |
| | | Reference Example | | | | | | | | | | |
| | | 1 | 2 | 3 | 4 | 5 | 6 | 7 | 8 | 9 | 10 | 11 |
| Operation | Target sheet | 0.3 | 0.3 | 0.3 | 0.3 | 0.3 | 0.3 | 0.3 | 0.3 | 0.3 | 0.3 | 0.3 |
| condition | thickness (mm) | | | | | | | | | | | |
| | Pressure (MPa) | 7 | 7 | 7 | 7 | 7 | 7 | 7 | 7 | 7 | 7 | 7 |
| | Heating set | 340 | 340 | 340 | 340 | 340 | 340 | 340 | 340 | 340 | 340 | 340 |
| | maximum | | | | | | | | | | | |
| | temperature | | | | | | | | | | | |
| | (° C.) | | | | | | | | | | | |
| | Conveyance | 0.5 | 0.5 | 0.5 | 0.5 | 0.5 | 0.5 | 0.5 | 0.5 | 0.5 | 0.5 | 0.5 |
| | speed (m/min) | | | | | | | | | | | |
| Thin sheet | Maximum sheet | 0.49 | 0.39 | 0.26 | 0.29 | 0.51 | 0.30 | 0.28 | 0.29 | 0.30 | 0.29 | 0.23 |
| thickness | thickness (mm) | | | | | | | | | | | |
| measure- | Minimum sheet | 0.37 | 0.18 | 0.23 | 0.20 | 0.22 | 0.21 | 0.21 | 0.25 | 0.20 | 0.21 | 0.16 |
| ment | thickness (mm) | | | | | | | | | | | |
| | Average sheet | 0.43 | 0.26 | 0.24 | 0.24 | 0.31 | 0.26 | 0.25 | 0.26 | 0.25 | 0.23 | 0.19 |
| | thickness (mm) | | | | | | | | | | | |
| | Sheet thickness | 0.04 | 0.07 | 0.01 | 0.03 | 0.10 | 0.03 | 0.02 | 0.01 | 0.04 | 0.03 | 0.03 |
| | standard | | | | | | | | | | | |
| | deviation (mm) | | | | | | | | | | | |
| Thermal | Hot disc method | 18 | 23 | 29 | 37 | 31 | 29 | 29 | 29 | 30 | 29 | 29 |
| conductivity | (W/mK) | | | | | | | | | | | |
| test | Temperature | 5.9 | 9.1 | 12 | 17 | 12 | 12 | 11 | 11 | 12 | 11 | 12 |
| | gradient | | | | | | | | | | | |
| | method | | | | | | | | | | | |
| | (W/mK) | | | | | | | | | | | |
| Electrical | Surface | 21 | 28 | 93 | 299 | 82 | 78 | 78 | 24 | 69 | 55 | 94 |
| conductivity | electrical | | | | | | | | | | | |
| test | conductivity | | | | | | | | | | | |
| | ((Ωm)⁻¹) | | | | | | | | | | | |
| | Resistance | 77 | 26 | 18 | 11 | 17 | 23 | 12 | 25 | 15 | 15 | 11 |
| | value in | | | | | | | | | | | |
| | penetrating | | | | | | | | | | | |
| | direction | | | | | | | | | | | |
| | (mΩm²) | | | | | | | | | | | |
| | Contact | 29 | 8.5 | 5.5 | 2.8 | 5.1 | 7.6 | 3.3 | 8.1 | 4.4 | 4.3 | 2.7 |
| | resistance | | | | | | | | | | | |
| | value (mΩm²) | | | | | | | | | | | |
| Tensile test | Tensile strength | 23 | 30 | 33 | 9.3 | 26 | 28 | 31 | 28 | 12 | 28 | 27 |
| | (MPa) | | | | | | | | | | | |
| | Tensile elastic | 7.5 | 12 | 20 | 12 | 14 | 10 | 11 | 10 | 5.7 | 11 | 11 |
| | modulus (Gpa) | | | | | | | | | | | |
| | Tensile | 0.26 | 0.21 | 0.15 | 0.05 | 0.15 | 0.20 | 0.27 | 0.26 | 0.18 | 0.23 | 0.21 |
| | elongation | | | | | | | | | | | |
| | rate (%) | | | | | | | | | | | |
| TG analysis | 5% weight loss | 508 | 508 | 517 | 533 | 522 | 457 | 425 | 418 | 444 | 429 | 429 |
| | temperature | | | | | | | | | | | |
| | (° C.) | | | | | | | | | | | |
| | | | | | Example and Comparative Example | | | | | | | |
| | | | | | | | | | | | Comparative | |
| | | | | | Example | | | | | | Example | |
| | | | | | 12 | 13 | 14 | 15 | 16 | 17 | 1 | 2 |
| | | | | | Reference Example and Comparative Reference Example | | | | | | | |
| | | | | | | | | | | | Comparative | |
| | | | | | | | | | | | Reference | |
| | | | | | Reference Example | | | | | | Example | |
| | | | | | 12 | 13 | 14 | 15 | 16 | 17 | 1 | 2 |

| | | | | | | | | | |
|---|---|---|---|---|---|---|---|---|---|
| Operation | Target sheet | 0.3 | 0.3 | 0.3 | 0.3 | 0.5 | 0.5 | 0.3 | 0.3 |
| condition | thickness (mm) | | | | | | | | |
| | Pressure (MPa) | 7 | 7 | 7 | 7 | 5 | 5 | 7 | 7 |
| | Heating set | 340 | 340 | 340 | 340 | 390 | 330 | 340 | 340 |
| | maximum | | | | | | | | |
| | temperature | | | | | | | | |
| | (° C.) | | | | | | | | |
| | Conveyance | 0.5 | 0.5 | 0.5 | 0.5 | 0.5 | 0.5 | 0.5 | 0.5 |
| | speed (m/min) | | | | | | | | |
| Thin sheet | Maximum sheet | 0.30 | 0.31 | 0.29 | 0.40 | 0.52 | 0.81 | 0.50 | — |
| thickness | thickness (mm) | | | | | | | | |
| measure- | Minimum sheet | 0.18 | 0.25 | 0.23 | 0.29 | 0.44 | 0.77 | 0.23 | |
| ment | thickness (mm) | | | | | | | | |
| | Average sheet | 0.26 | 0.28 | 0.26 | 0.34 | 0.48 | 0.79 | 0.33 | |
| | thickness (mm) | | | | | | | | |
| | Sheet thickness | 0.05 | 0.02 | 0.02 | 0.04 | 0.02 | 0.01 | 0.09 | |
| | standard | | | | | | | | |
| | deviation (mm) | | | | | | | | |
| Thermal | Hot disc method | 29 | 30 | 29 | 31 | 33 | 32 | 4.5 | |
| conductivity | (W/mK) | | | | | | | | |
| test | Temperature | 11 | 12 | 12 | 12 | 10 | 13 | 1.2 | |
| | gradient | | | | | | | | |
| | method | | | | | | | | |
| | (W/mK) | | | | | | | | |
| Electrical | Surface | 71 | 62 | 104 | 96 | 23 | 22 | 2.5 | |
| conductivity | electrical | | | | | | | | |
| test | conductivity | | | | | | | | |
| | ((Ωm)⁻¹) | | | | | | | | |
| | Resistance | 11 | 18 | 9.9 | 9.9 | 18 | 6.2 | 420 | |
| | value in | | | | | | | | |
| | penetrating | | | | | | | | |
| | direction | | | | | | | | |
| | (mΩm²) | | | | | | | | |
| | Contact | 2.8 | 5.5 | 2.3 | 2.3 | 5.3 | 8.0 | 155 | |
| | resistance | | | | | | | | |
| | value (mΩm²) | | | | | | | | |
| Tensile test | Tensile strength | 27 | 11 | 6.6 | 6.5 | 37 | 30 | 15 | |
| | (MPa) | | | | | | | | |
| | Tensile elastic | 11 | 4.4 | 4.3 | 6.1 | 15 | 13 | 4.5 | |
| | modulus (Gpa) | | | | | | | | |
| | Tensile | 0.22 | 0.28 | 0.11 | 0.10 | 0.43 | 0.37 | 0.85 | |
| | elongation | | | | | | | | |
| | rate (%) | | | | | | | | |
| TG analysis | 5% weight loss | 430 | 417 | 416 | 424 | 570 | 507 | 502 | |
| | temperature | | | | | | | | |
| | (° C.) | | | | | | | | |

From the results shown in Table 3, it is found that as the filler concentration increases, the thermal conductivity and the electrical conductivity increase, the electrical resistance value and the contact resistance value in the penetrating direction decrease, and there is a threshold of an infinite cluster of the thermal conductivity and electrical conductivity at a filler concentration of 20 to 40 wt % (Examples 1 to 4). It is found that the addition of the thermoplastic elastomer decreases the tensile elastic modulus, increases the elongation rate, and can improve mechanical properties (brittleness), and although a difference in numerical value is slight, it becomes considerably easy to handle the thin sheet, and the thermal characteristics and the electrical characteristics are improved by improving the smoothness at the interface (Examples 6 to 9 and 13). Since the thermal characteristics and the electrical characteristics are not impaired even by the addition of the uncured thermosetting resin, it is found that the addition of the uncured thermosetting resin can contribute to improvement of adhesiveness between different materials (Examples 10 to 12, 14, and 15). The 5% weight loss temperature was reduced by conversion of the PPS resin to nylon 6 and addition of the thermoplastic elastomer and the uncured thermosetting resin (Examples 1 to 15). By changing the PPS resin to a heat-resistant thermoplastic polyimide resin, the 5% weight loss temperature was significantly increased (Example 16), and this value was found to strongly depend on the type (heat resistance) of polymer particles. By using a scale-like graphite aggregate (Example 17) in combination with the scale-like graphite (Example 3), the thermal conductivity slightly increases.

In Comparative Example 1, the thermal conductivity of the thin sheet was low, and the filler concentration was not sufficient to form a thermally conductive infinite cluster. In Comparative Example 2, the filler concentration was too high, and as a result, the thin sheet was too brittle, and various physical properties could not be measured.

### Comparative Example 3 (Production of Thin Sheet Using Powder Film Forming Machine)

An attempt was made to prepare a thin sheet by using a powder film forming machine (film formable width 50 mm to 300 mm, roll diameter 9300, line speed 1 to 10 m/min) manufactured by HIRANO GIKENKOGYO Co., Ltd., in which opposing press rolls are rotated inward and continuously compressed by the pressure between the rolls to form a film, charging the powder composition (scale-like graphite 75%, PPS resin 25%) of Reference Example 3 from the upper part of the powder film forming machine, and changing conditions such as the charged amount and the line speed at a temperature higher than or equal to the melting point of the PPS resin and at a high pressure (linear pressure), but a sheet-shaped thin sheet could not be obtained.

### Comparative Example 4 (Production of Thin Sheet Using Roll Press Machine

An attempt was made to prepare a thin sheet having a thickness of 0.5 mm to 1 mm at a temperature higher than or equal to the melting point of a PPS resin and a pressure (linear pressure) by uniformly spreading the powder composition (scale-like graphite 75%, PPS resin 25%) of Reference Example 3 in a 300 mm long×600 mm wide mold frame placed on a heat-resistant polyimide release film to prepare a test piece covering the release film thereon, and conveying the test piece from the horizontal direction to a roll press machine by using a roll press machine manufactured by HIRANO GIKENKOGYO Co., Ltd. capable of applying a pressure of up to 15 t to the width of the substrate. However, in the obtained sheet, concavities and convexities on the surface were severe.

### Examples 18 to 28 (Influence of Heating Temperature, Pressure, Conveyance Speed, Sheet Thickness, and Number of Times of Conveying in Production of Conductive Thin Sheet)

A conductive thin sheet was prepared according to Example 3, except that the powder composition and the operating conditions were changed as shown in Table 4, and the influence of the heating temperature, the pressure, the conveyance speed, and the sheet thickness was examined. In place of Reference Example 3, the thin sheet obtained in each of Examples 19 and 24 was conveyed again to a double belt press device according to Example 3 to prepare a reprocessed thin sheet. Measurement of the sheet thickness at six places of the reprocessed thin sheet obtained in this manner, a liquid penetrant test, a thermal conductivity test, an electrical conductivity test, a tensile test, and TG analysis were performed. The obtained results are shown in Table 4 as Examples 18 to 28.

TABLE 4
Influence of temperature, pressure, conveyance speed, sheet thickness, and number of times of conveying in conductive thin sheet

| | | Example | | | | | | | | | | |
|---|---|---|---|---|---|---|---|---|---|---|---|---|
| | | 18 | 19 | 20 | 21 | 22 | 23 | 24 | 25 | 26 | 27 | 28 |
| | | Reference Example | | | | | | | | | | |
| | | | | | | | | | | | Example | Example |
| | | 3 | 3 | 3 | 3 | 3 | 3 | 3 | 3 | 3 | 19 | 24 |
| Operation | Target sheet thickness (mm) | 0.45 | 0.45 | 0.45 | 0.45 | 0.45 | 0.45 | 0.45 | 0.3 | 0.6 | 0.45 | 0.45 |
| condition | Pressure (MPa) | 7 | 7 | 7 | 2 | 5 | 7 | 7 | 7 | 7 | 10 | 7 |
| | Heating set maximum | 280 | 300 | 320 | 320 | 320 | 320 | 320 | 320 | 320 | 300 | 340 |
| | temperature (° C.) | | | | | | | | | | | |
| | Conveyance speed (m/min) | 0.5 | 0.5 | 0.5 | 0.5 | 0.5 | 0.25 | 1.0 | 0.5 | 0.5 | 0.5 | 1.0 |
| | Number of times of conveying | 1 | 1 | 1 | 1 | 1 | 1 | 1 | 1 | 1 | 2 | 2 |
| Thin sheet | Maximum sheet thickness (mm) | 0.41 | 0.58 | 0.48 | 0.52 | 0.51 | 0.39 | 0.39 | 0.21 | 0.72 | 0.50 | 0.35 |
| thickness | Minimum sheet thickness (mm) | 0.27 | 0.45 | 0.41 | 0.39 | 0.40 | 0.28 | 0.25 | 0.17 | 0.61 | 0.42 | 0.25 |
| measurement | Average sheet thickness (mm) | 0.34 | 0.51 | 0.44 | 0.46 | 0.45 | 0.34 | 0.29 | 0.18 | 0.68 | 0.45 | 0.26 |
| | Sheet thickness standard | 0.05 | 0.04 | 0.03 | 0.05 | 0.04 | 0.04 | 0.05 | 0.02 | 0.04 | 0.02 | 0.03 |
| | deviation (mm) | | | | | | | | | | | |
| Liquid | Presence or absence of liquid | Δ | ◯ | ◯ | Δ | ◯ | ◯ | Δ | Δ | ⊙ | ⊙ | ⊙ |
| penetrant test | penetration (⊙, ◯, Δ, X) | | | | | | | | | | | |
| Thermal | Hot disc method (W/mK) | 29 | 30 | 30 | 29 | 29 | 29 | 29 | 31 | 29 | 30 | 29 |
| conductivity | Temperature gradient method | 11 | 12 | 12 | 11 | 12 | 12 | 11 | 12 | 11 | 12 | 11 |
| test | (W/mK) | | | | | | | | | | | |
| Electrical | Surface electrical conductivity | 155 | 137 | 183 | 145 | 149 | 134 | 157 | 108 | 151 | 137 | 157 |
| conductivity | ((Ωm)⁻¹) | | | | | | | | | | | |
| test | Resistance value in penetrating | 15 | 19 | 19 | 14 | 16 | 16 | 16 | 17 | 19 | 19 | 16 |
| | direction (mΩm²) | | | | | | | | | | | |
| | Contact resistance value | 4.4 | 5.7 | 6.0 | 4.0 | 4.6 | 4.6 | 4.6 | 5.0 | 5.7 | 5.7 | 4.6 |
| | (mΩm²) | | | | | | | | | | | |
| Tensile test | Tensile strength (MPa) | 28 | 32 | 31 | 27 | 34 | 35 | 34 | 32 | 32 | 32 | 34 |
| | Tensile elastic modulus (Gpa) | 16 | 14 | 16 | 15 | 14 | 15 | 14 | 16 | 11 | 14 | 14 |
| | Tensile elongation rate (%) | 0.19 | 0.23 | 0.22 | 0.17 | 0.23 | 0.21 | 0.20 | 0.16 | 0.30 | 0.23 | 0.20 |
| TG analysis | 5% weight loss temperature | 521 | 537 | 524 | 529 | 525 | 516 | 523 | 522 | 520 | 537 | 523 |
| | (° C.) | | | | | | | | | | | |

From the results shown in Table 4, it was found that by increasing the heating temperature, the pressure, and the sheet thickness, the liquid permeability (generation of extremely fine cracks) can be suppressed without significantly affecting various physical properties, and the liquid permeability is increased when the conveyance speed is excessively increased. It was found that by increasing the number of times of conveyance, it is possible to improve the uniformity of the sheet thickness, reduce the thickness, and suppress the liquid permeability.

### Examples 29 to 42 (Influence of Type and Concentration of Highly Thermally Conductive Filler and Organic Polymer, and Additive in Production of Insulating Thin Sheet)

Insulating thin sheets of Examples 29 to 42 were prepared according to Example 3, except that the powder composition was changed as shown in Table 5. Measurement of the sheet thickness at six places of each insulating thin sheet thus obtained, a thermal conductivity test, an insulation property test, a tensile test, and TG analysis were performed to examine the influence of the type and concentration of the insulating filler, the type and concentration of the organic polymer, and the additive. The results are shown in Table 5.

TABLE 5

| | | Example | | | | | | | |
|---|---|---|---|---|---|---|---|---|---|
| | | 29 | 30 | 31 | 32 | 33 | 34 | 35 | 36 |
| | | Reference Example | | | | | | | |
| | | 18 | 19 | 20 | 21 | 22 | 23 | 24 | 25 |
| Operation | Target sheet | 0.30 | 0.30 | 0.30 | 0.30 | 0.30 | 0.30 | 0.30 | 0.40 |
| condition | thickness (mm) | | | | | | | | |
| | Pressure (MPa) | 5 | 5 | 5 | 5 | 5 | 5 | 5 | 5 |
| | Heating set | 340 | 340 | 340 | 340 | 340 | 340 | 340 | 330 |
| | maximum | | | | | | | | |
| | temperature | | | | | | | | |
| | (° C.) | | | | | | | | |
| | Conveyance | 0.5 | 0.5 | 0.5 | 0.5 | 0.5 | 0.5 | 0.5 | 0.5 |
| | speed | | | | | | | | |
| | (m/min) | | | | | | | | |
| Thin sheet | Maximum sheet | 0.55 | 0.49 | 0.50 | 0.54 | 0.56 | 0.44 | 0.64 | 0.40 |
| thickness | thickness (mm) | | | | | | | | |
| measure- | Minimum sheet | 0.43 | 0.29 | 0.23 | 0.27 | 0.32 | 0.39 | 0.43 | 0.33 |
| ment | thickness (mm) | | | | | | | | |
| | Average sheet | 0.48 | 0.42 | 0.35 | 0.41 | 0.42 | 0.42 | 0.50 | 0.36 |
| | thickness (mm) | | | | | | | | |
| | Sheet thickness | 0.04 | 0.06 | 0.06 | 0.10 | 0.08 | 0.02 | 0.06 | 0.02 |
| | standard | | | | | | | | |
| | deviation (mm) | | | | | | | | |
| Thermal | Hot disc method | 12 | 13 | 18 | 19 | 19 | 19 | 13 | 12 |
| conductivity | (W/mK) | | | | | | | | |
| test | Temperature | 5.6 | 6.5 | 7.8 | 7.9 | 8.0 | 7.9 | 6.2 | 6.2 |
| | gradient | | | | | | | | |
| | method (W/mK) | | | | | | | | |
| Insulation | Surface | <10⁻¹⁶ | <10⁻¹⁶ | <10⁻¹⁶ | <10⁻¹⁶ | <10⁻¹⁶ | <10⁻¹⁶ | <10⁻¹⁶ | 6 × 10⁻¹⁶ |
| property | electrical | | | | | | | | |
| test | conductivity | | | | | | | | |
| | ((Ωm)⁻¹) | | | | | | | | |
| | Cross-section | <10⁻¹⁶ | <10⁻¹⁶ | <10⁻¹⁶ | 2 × 10⁻¹⁶ | 4 × 10⁻¹⁶ | 4 × 10⁻¹⁶ | 7 × 10⁻¹⁶ | <10⁻¹⁶ |
| | electrical | | | | | | | | |
| | conductivity | | | | | | | | |
| | ((Ωm)⁻¹) | | | | | | | | |
| | Dielectric | 52 | 45 | 41 | 40 | 40 | 41 | 43 | 43 |
| | breakdown | | | | | | | | |
| | voltage | | | | | | | | |
| | (kV/mm) | | | | | | | | |
| Dielectric | Dielectric | — | 3.4 | — | — | — | — | — | 3.0 |
| property | constant | | | | | | | | |
| test | Dielectric loss | — | 0.0017 | — | — | — | — | — | 0.0015 |
| | tangent | | | | | | | | |
| Tensile test | Tensile strength | 34 | 32 | 19 | 19 | 17 | 20 | 26 | 18 |
| | (MPa) | | | | | | | | |
| | Tensile elastic | 12 | 12 | 11 | 9.5 | 12 | 12 | 9.1 | 13 |
| | modulus (Gpa) | | | | | | | | |
| | Tensile | 0.28 | 0.21 | 0.09 | 0.12 | 0.11 | 0.13 | 0.26 | 0.22 |
| | elongation | | | | | | | | |
| | rate (%) | | | | | | | | |
| TG analysis | 5% weight loss | 512 | 514 | 524 | 459 | 431 | 442 | 439 | 457 |
| | temperature | | | | | | | | |
| | (° C.) | | | | | | | | |
| | | | | Example | | | | | |
| | | | | 37 | 38 | 39 | 40 | 41 | 42 |
| | | | | Reference Example | | | | | |
| | | | | 26 | 27 | 28 | 29 | 30 | 31 |
| | | Operation | Target sheet | 0.40 | 0.40 | 0.40 | 0.40 | 0.40 | 0.40 |
| | | condition | thickness (mm) | | | | | | |
| | | | Pressure (MPa) | 5 | 5 | 5 | 5 | 5 | 5 |
| | | | Heating set | 330 | 350 | 330 | 330 | 330 | 330 |
| | | | maximum | | | | | | |
| | | | temperature | | | | | | |
| | | | (° C.) | | | | | | |
| | | | Conveyance | 0.5 | 0.5 | 0.5 | 0.5 | 0.5 | 0.5 |
| | | | speed | | | | | | |
| | | | (m/min) | | | | | | |
| | | Thin sheet | Maximum sheet | 0.41 | 0.38 | 0.34 | 0.55 | 0.48 | 0.49 |
| | | thickness | thickness (mm) | | | | | | |
| | | measure- | Minimum sheet | 0.32 | 0.33 | 0.24 | 0.46 | 0.41 | 0.43 |
| | | ment | thickness (mm) | | | | | | |
| | | | Average sheet | 0.35 | 0.35 | 0.28 | 0.51 | 0.46 | 0.45 |
| | | | thickness (mm) | | | | | | |
| | | | Sheet thickness | 0.03 | 0.02 | 0.04 | 0.03 | 0.02 | 0.02 |
| | | | standard | | | | | | |
| | | | deviation (mm) | | | | | | |
| | | Thermal | Hot disc method | 14 | 13 | 12 | 15 | 8.2 | 14 |
| | | conductivity | (W/mK) | | | | | | |
| | | test | Temperature | 7.3 | 6.6 | 4.5 | 13 | 3.6 | 7.0 |
| | | | gradient | | | | | | |
| | | | method (W/mK) | | | | | | |
| | | Insulation | Surface | 1 × 10⁻¹⁶ | 4 × 10⁻¹⁶ | 6 × 10⁻¹⁵ | 4 × 10⁻¹⁶ | 6 × 10⁻¹⁶ | 1 × 10⁻¹⁶ |
| | | property | electrical | | | | | | |
| | | test | conductivity | | | | | | |
| | | | ((Ωm)⁻¹) | | | | | | |
| | | | Cross-section | <10⁻¹⁶ | 6 × 10⁻¹⁶ | <10⁻¹⁶ | <10⁻¹⁶ | <10⁻¹⁶ | <10⁻¹⁶ |
| | | | electrical | | | | | | |
| | | | conductivity | | | | | | |
| | | | ((Ωm)⁻¹) | | | | | | |
| | | | Dielectric | 40 | 44 | 38 | 32 | 42 | 39 |
| | | | breakdown | | | | | | |
| | | | voltage | | | | | | |
| | | | (kV/mm) | | | | | | |
| | | Dielectric | Dielectric | 3.2 | 3.3 | 2.8 | — | — | — |
| | | property | constant | | | | | | |
| | | test | Dielectric loss | 0.0018 | 0.0034 | 0.0017 | — | — | — |
| | | | tangent | | | | | | |
| | | Tensile test | Tensile strength | 18 | 21 | 2.7 | 23 | 19 | 26 |
| | | | (MPa) | | | | | | |
| | | | Tensile elastic | 12 | 15 | — | 11 | 8.1 | 18 |
| | | | modulus (Gpa) | | | | | | |
| | | | Tensile | 0.26 | 0.23 | 0.35 | 0.35 | 0.39 | 0.23 |
| | | | elongation | | | | | | |
| | | | rate (%) | | | | | | |
| | | TG analysis | 5% weight loss | 441 | 578 | 493 | 442 | 417 | 510 |
| | | | temperature | | | | | | |
| | | | (° C.) | | | | | | |

From the results shown in Table 5, it is found that by increasing the filler concentration, the thermal conductivity and the 5% weight loss temperature are increased, but the dielectric breakdown voltage, the tensile strength, and the elongation rate are slightly reduced (Examples 29 to 31). It is found that by adding the thermoplastic elastomer and the thermosetting resin, the tensile elongation rate can be increased while the thermal conductivity is maintained (comparison between Example 30 and Example 35 and comparison between Example 31 and Examples 32 to 35). As described above, since the thermosetting resin can be introduced into the thin sheet without greatly affecting various physical properties, it is found that the thermosetting resin can contribute to improvement of adhesiveness with different materials such as metals.

By using the PPE resin in combination with the PPS resin, the elastic modulus could be slightly increased (comparison between Example 30 and Example 36). By using a flexible nylon 12 resin in combination, the thermal conductivity was increased, and the tensile elongation rate could be improved (comparison between Examples 30 and 37), and the effect of adding a modifier was obtained. Although the thermal characteristics (5 wt % loss temperature) were impaired by the addition of the amorphous polymer (PPE resin) and the elastomer (nylon 12 resin), it is considered that a filler-rich phase and a filler-non-rich phase were formed, and the effect of mixing both the phases became apparent. By using the PEEK resin instead of the PPS resin, the 5 wt % loss temperature could be significantly increased without significantly affecting other physical properties. By using a fluororesin and a fluoroelastomer combined system, the dielectric constant could be significantly reduced (comparison between Example 30 and Examples 38 and 39). By using aggregated type boron nitride in combination with flat boron nitride, the thermal conductivity in the temperature gradient method could be significantly increased and the anisotropy could be improved (comparison between Example 37 and Example 40). The thermal conductivity was decreased by replacing the PPS resin with an SPS resin containing 30% of the elastomer, but this was considered to be due to the inclusion of the elastomer (comparison between Example 36 and Example 41) because the elongation rate was increased and the tensile elastic modulus was significantly decreased, and it was found that the tensile elastic modulus can be significantly improved without decreasing the thermal conductivity by adding 5 wt % of fibrous basic magnesium oxide which is a whisker-like ceramics in the PPS resin system containing 65 wt % of boron nitride (comparison between Example 30 and Example 42).

As described above, the morphology can be greatly improved by the formation of a filler-rich phase and a filler-non-rich phase, the shape of the filler, and the like, and the thermal conductivity, the dielectric properties, and the mechanical properties can be improved, depending on the type, the used amount, and the combination of the thermoplastic resin and the insulating filler.

### Examples 43 to 50 (Production of Copper-Clad Sheet and Characteristics Thereof)

Insulating thin copper-clad sheets of Examples 43 to 50 were prepared according to Example 2, except that the powder composition was changed as shown in Table 6, and the upper release film was changed to a copper foil. Measurement of the sheet thickness at six places of each insulating thin sheet thus obtained and a peel test were performed to examine the influence of the type of the insulating filler, the type and concentration of the thermoplastic polymer particles, and the thermoplastic elastomer. For the copper foil, an adhesive was applied to the thin sheet joint surface (application thickness: about 20 μm), and comparison with an untreated product was performed.

TABLE 6

| | | Example | | | | | | | |
|---|---|---|---|---|---|---|---|---|---|
| | | 43 | 44 | 45 | 46 | 47 | 48 | 49 | 50 |
| | | Reference Example | | | | | | | |
| | | 19 | 19 | 25 | 26 | 27 | 28 | 29 | 31 |
| Presence or absence of adhesive | | X | ◯ | ◯ | ◯ | ◯ | ◯ | ◯ | ◯ |
| treatment of copper foil (◯ X) | | | | | | | | | |
| Operation | Target sheet thickness | 0.40 | 0.40 | 0.40 | 0.40 | 0.40 | 0.40 | 0.40 | 0.40 |
| condition | (mm) | | | | | | | | |
| | Pressure (MPa) | 5 | 5 | 5 | 5 | 5 | 5 | 5 | 5 |
| | Heating set maximum | 340 | 340 | 330 | 330 | 350 | 330 | 330 | 330 |
| | temperature (° C.) | | | | | | | | |
| | Conveyance speed | 0.5 | 0.5 | 0.5 | 0.5 | 0.5 | 0.5 | 0.5 | 0.5 |
| | (m/min) | | | | | | | | |
| Thin sheet | Maximum sheet thickness | 0.45 | 0.48 | 0.44 | 0.41 | 0.42 | 0.37 | 0.58 | 0.57 |
| thickness | (mm) | | | | | | | | |
| measurement | Minimum sheet thickness | 0.39 | 0.48 | 0.39 | 0.39 | 0.38 | 0.34 | 0.54 | 0.46 |
| | (mm) | | | | | | | | |
| | Average sheet thickness | 0.42 | 0.48 | 0.41 | 0.40 | 0.40 | 0.35 | 0.56 | 0.51 |
| | (mm) | | | | | | | | |
| | Sheet thickness standard | 0.02 | 0.00 | 0.02 | 0.01 | 0.02 | 0.01 | 0.02 | 0.03 |
| | deviation (mm) | | | | | | | | |
| Peel test | Adhesive strength | 0.26 | 0.78 | 0.57 | 0.45 | 0.51 | 0.27 | 0.67 | 0.68 |
| | (N/mm) | | | | | | | | |

From the results shown in Table 6, the thin sheet thickness was increased to about the thickness of the copper foil (30 μm), and the dielectric breakdown voltage did not change significantly depending on the presence or absence of the copper foil. As for the adhesive strength with the copper foil, the adhesive strength was improved about 3 times by applying the adhesive to the copper foil (comparison between Example 43 and Example 44), and the adhesive strength was slightly reduced by using the PPE resin and the nylon 12 resin in combination (comparison between Example 44 and Examples 45 and 46). When a PEEK resin and a fluororesin-fluoroelastomer combined system were used instead of the PPS resin, the adhesive strength was only slightly reduced in the former, but was remarkably reduced in the latter, but the copper foil was not peeled off (comparison between Example 44 and Examples 47 and 48). In the thin sheet of Example 40, a high thermal conductivity could be obtained by using aggregated boron nitride and a PPE resin in combination (Reference Example 29), but a high adhesive strength was also exhibited in the copper-clad sheet (Example 49). It was found that by adding the whisker-like ceramics, warpage based on a difference in expansion coefficient between the copper foil and the resin layer is improved without significantly decreasing the adhesive strength (comparison between Example 44 and Example 50).

FIG. 2 shows nitrogen atom mapping (white part) in SEM/EDX analysis of an interface between the copper foil and the resin of the copper-clad sheet obtained in Example 44, and a black part 1 shows an uneven cross-section of the copper foil surface. A white part 2 shows that a large amount of nitrogen atoms derived from boron nitride (BN) is present. A black part 3 shows that a large amount of PPS resin containing no nitrogen atom is present. Since a powdery material was used as a raw material, it is found that the insulating filler BN penetrates through an adhesive layer and adheres to the copper foil even though an adhesive was used. Adhesion between the copper foil and the insulating filler inhibits an adverse effect on thermal conductivity due to use of the adhesive.

### Example 51 (Continuous Production of Conductive Thin Sheet)

FIG. 1 illustrates a continuous production device for a thin sheet in which a vibratory conveying device provided with a hopper is connected to a double belt press device instead of a mold frame. The powder composition obtained in Reference Example 3 was charged from a hopper into a vibratory conveying device equipped with a hopper manufactured by Makino Corporation, the powder composition was adjusted so that the powder composition could be continuously supplied onto a release film at a height of about 2 cm using the vibratory conveying machine, the release film was further covered on the powder composition, the powder composition was supplied to a double belt press device manufactured by Morita Giken Inc. as illustrated in FIG. 1, and a conductive thin sheet having a target sheet thickness of 0.3 mm was continuously produced in accordance with Example 3. As a result, it was confirmed that a conductive thin sheet similar to that in Example 3 was continuously obtained.

### INDUSTRIAL APPLICABILITY

Since the thin sheet of the present invention has excellent electrical conductivity and/or insulation properties and is excellent in weight reduction, mechanical strength, designability, moldability, mass productivity, recyclability, and the like, the thin sheet is useful for fuel cell separators, lithium ion battery materials, TIM for power devices, LED heat dissipation materials, casings for smartphones, members for high-frequency amplifiers, low dielectric constant-low dielectric loss tangent materials for electrical or electronic devices of 5G or 6G, and the like. In particular, use of the double belt press device as a heating and pressure-molding device can contribute to remarkable improvement in productivity and cost reduction as compared with the conventional heat press device.

The present application is based on Japanese Patent Application No. 2021-024170 filed on Feb. 18, 2021, the disclosure content of which is incorporated herein by reference in its entirety.

1. A high filler-loaded thermally conductive thin sheet, formed by
obtaining a powder composition including organic polymer particles containing a thermoplastic polymer and highly thermally conductive filler particles including filler particles having a graphite-like structure with a thermal conductivity of 10 W/mK or more, the powder composition having conditions that 5 to 60 wt % of the organic polymer particles and 40 to 95 wt % of the highly thermally conductive filler particles with respect to 100 wt % of the total amount of the organic polymer particles and the highly thermally conductive filler particles are uniformly dispersed using a pulverizer or a mixer, a thermally conductive infinite cluster is formed, and a concentration of the thermally conductive filler is more than or equal to a percolation threshold,
conveying, using a conveying device, the powder composition at a constant thickness between a first belt and a second belt of a double belt press device, the double belt press device including the first belt made of metal that is wound around a plurality of first driving rollers and circulates, the second belt made of metal that is wound around a plurality of second driving rollers and circulates below the first belt, and a pressurizing device and a heating device, or a pressurizing device, a heating device, and a cooling device that are respectively disposed between the plurality of first driving rollers and between the plurality of second driving rollers in a pressurization region where the first belt and the second belt face each other, and
continuously heating and pressurizing the powder composition conveyed at a constant thickness at a temperature of 150 to 400° C. that is higher than or equal to a deflection temperature under load, melting point, or glass transition temperature of the organic polymer and at a pressure of 0.05 to 30 MPa and then cooling and solidifying the powder composition in the double belt press device, the high filler-loaded thermally conductive thin sheet having a thickness of 0.05 to 3 mm, a thickness standard deviation of 0.08 mm or less, and a thermal conductivity in a plane direction as measured by a hot disc method of 5 to 150 W/mK, and a value of a ratio of the thermal conductivity in the plane direction to a thermal conductivity in a depth direction as measured by a temperature gradient method of 15/13 to 180/59.

2. The high filler-loaded thermally conductive thin sheet according to claim 1, wherein the thickness is 0.18 to 0.79 mm.

3-5. (canceled)

6. The high filler-loaded thermally conductive thin sheet according to claim 1, wherein the thermoplastic polymer particles include at least one selected from the group consisting of thermoplastic resin particles and thermoplastic elastomer particles all of which have crystallinity and/or aromaticity.

7. The high filler-loaded thermally conductive thin sheet according to claim 1, wherein the thermoplastic polymer particles include the thermoplastic resin particles having crystallinity and/or aromaticity and a thermoplastic elastomer including a non-particulate shape.

8. The high filler-loaded thermally conductive thin sheet according to claim 6, wherein the thermoplastic resin particles include at least one selected from the group consisting of polytetrafluoroethylene, a copolymer of tetrafluoroethylene and perfluoroalkyl vinyl ether, polyphenylene sulfide, polyethylene terephthalate, polybutylene terephthalate, semi-aromatic polyamide, aliphatic polyamide, polypropylene, heat-resistant polyimide, polyether sulfone, polyether ether ketone, syndiotactic polystyrene, polyphenylene ether, and polycarbonate.

9. The high filler-loaded thermally conductive thin sheet according to claim 6, wherein the thermoplastic elastomer particles include at least one selected from the group consisting of a polystyrene-based elastomer, a polyamide-based elastomer, and a fluoro-rubber-based elastomer.

10. The high filler-loaded thermally conductive thin sheet according to claim 1, wherein the organic polymer particles contain a thermosetting elastomer.

11-15. (canceled)

16. The high filler-loaded thermally conductive thin sheet according to claim 1, wherein the highly thermally conductive filler particles contain graphite.

17. The high filler-loaded thermally conductive thin sheet according to claim 16, wherein the graphite contains at least one selected from the group consisting of natural graphite, artificial graphite, and expanded graphite.

18. The high filler-loaded thermally conductive thin sheet according to claim 1, wherein the highly thermally conductive filler particles contain thermally conductive ceramics.

19. The high filler-loaded thermally conductive thin sheet according to claim 18, wherein the thermally conductive ceramics contains hexagonal boron nitride.

20. The high filler-loaded thermally conductive thin sheet according to claim 18, wherein a dielectric constant is 2.0 to 4.5, and a dielectric loss tangent is 0.0005 to 0.015.

21. The high filler-loaded thermally conductive thin sheet according to claim 20, wherein a dielectric constant and a dielectric loss tangent of the thermoplastic resin are 2.0 to 3.7 and 0.00001 to 0.005, respectively, and a dielectric constant and a dielectric loss tangent of the highly thermally conductive filler are 3.0 to 5.0 and 0.00001 to 0.005, respectively.

22. The high filler-loaded thermally conductive thin sheet according to claim 19, wherein the organic polymer particles include at least one selected from the group consisting of polyphenylene sulfide, polytetrafluoroethylene, a copolymer of tetrafluoroethylene and perfluoroalkyl vinyl ether, polyether ether ketone, heat-resistant polyimide, polyphenylene ether, and a liquid crystalline polyester polymer, and the highly thermally conductive filler particles include hexagonal boron nitride.

23. The high filler-loaded thermally conductive thin sheet according to claim 19, wherein the powder composition further contains whisker-like ceramics.

24. The high filler-loaded thermally conductive sheet according to claim 18, wherein a thermal conductivity and a surface electrical conductivity of the thermally conductive infinite cluster are 5 to 50 W/mK and 10⁻¹⁰ (Ωcm)⁻¹, respectively.

25. The high filler-loaded thermally conductive sheet according to claim 1, wherein the organic polymer particles contain a thermoplastic polymer and an uncured thermosetting resin, a deflection temperature under load or melting point of the thermoplastic polymer is equal to or lower than a curing temperature of the thermosetting resin, and a heating temperature in the double belt press device is a temperature higher than or equal to the deflection temperature under load or melting point of the thermoplastic polymer and equal to or lower than the curing temperature of the thermosetting resin.

26-43. (canceled)
